(19) United States
(12) Patent Application Publication
(10) Pub. No.: US 2026/0195435 A1
(43) Pub. Date: Jul. 9, 2026

(54) SERVER APPARATUS, SYSTEM, CONTROL METHOD OF SERVER APPARATUS, AND STORAGE MEDIUM

(71) Applicant: NEC Corporation, Tokyo (JP)

(72) Inventors: Yoshihisa SHINGU, Tokyo (JP); Tomohide OTA, Tokyo (JP); Issei YANAGISAWA, Tokyo (JP); Daisuke SHIBUICHI, Tokyo (JP)

(73) Assignee: NEC Corporation, Tokyo (JP)

(21) Appl. No.: 19/132,944

(22) PCT Filed: Dec. 7, 2022
(86) PCT No.: PCT/JP2022/045178

§ 371 Date: May 27, 2025

(51) Int. Cl. G06F 21/32

(52) U.S. Cl. CPC G06F 21/32

(57) ABSTRACT

A server apparatus includes a service selection control means and a storage means. The service selection control means enables a user to select a service provider, the service provider being one from which the user desires to receive a service, from among a plurality of service providers that provide services using biometric authentication. The storage means stores information of the service provider that the user has selected. The service selection control means enables the user, at the time of selecting the service provider from which the user desires to receive the service, to distinguish between a service provider that has already been selected by the user and a service provider that has not yet been selected.

### TECHNICAL FIELD

The present invention relates to a server apparatus, a system, a control method of a server apparatus, and a storage medium.

### BACKGROUND ART

There exists a technology related to biometric authentication.

For example, Patent Literature 1 describes that there is provided an authentication server capable of performing authentication using biometric information with increased reassurance. Patent Literature 2 describes that there is provided an authentication system, a method, and a program that enable only true users to easily use a plurality of online services. Patent Literature 3 describes that there is provided a biometric authentication service that achieves a balance among economy, popularity, and safety.

### CITATION LIST

### Patent Literature

[PTL 1] International Publication WO2021/205661
[PTL 2] Japanese Unexamined Patent Application Publication No. JP2018-074388
[PTL 3] Japanese Unexamined Patent Application Publication No. JP2016-149087

### SUMMARY OF INVENTION

### Technical Problem

In recent years, provision of various services using biometric authentication has begun. As the provision of services using biometric authentication becomes more widespread, users develop a desire to manage the service providers that hold their biometric information. Specifically, the user wishes to provide biometric information to service providers from which the user desires to receive services, and wishes to delete their biometric information from service providers from which the user does not plan to receive services. That is, the user desires to perform selection (opt-in) or exclusion (opt-out) of business operators that provide services using biometric authentication, based on the user's own intention. For that purpose, it becomes necessary for the user to be able to grasp the status of each service provider.

The present invention primarily aims to provide a server apparatus, a system, a control method of a server apparatus, and a storage medium, which contribute to enabling a user to grasp the status of each business operator that provides services using biometric authentication.

### Solution to Problem

According to a first aspect of the present invention, there is provided a server apparatus, including: a service selection control means that enables a user to select a service provider, the service provider being one from which the user desires to receive a service, from among a plurality of service providers that provide services using biometric authentication; and a storage means that stores information of the service provider that the user has selected, wherein the service selection control means enables the user, at the time of selecting the service provider from which the user desires to receive the service, to distinguish between a service provider that has already been selected by the user and a service provider that has not yet been selected.

According to a second aspect of the present invention, there is provided a system, including: a terminal possessed by the user; and a server apparatus, wherein the server apparatus includes: a service selection control means that enables a user to select a service provider, the service provider being one from which the user desires to receive a service, from among a plurality of service providers that provide services using biometric authentication; and a storage means that stores information of the service provider that the user has selected, wherein the service selection control means enables the user, at the time of selecting the service provider from which the user desires to receive the service, to distinguish between a service provider that has already been selected by the user and a service provider that has not yet been selected.

According to a third aspect of the present invention, there is provided a control method of a server apparatus, the control method including: enabling a user to select a service provider, the service provider being one from which the user desires to receive a service, from among a plurality of service providers that provide services using biometric authentication; storing information of the service provider that the user has selected; and enabling the user, at the time of selecting the service provider from which the user desires to receive the service, to distinguish between a service provider that has already been selected by the user and a service provider that has not yet been selected.

According to a fourth aspect of the present invention, there is provided a computer-readable storage medium storing a program causing a computer mounted on a server apparatus to perform processing for: enabling a user to select a service provider, the service provider being one from which the user desires to receive a service, from among a plurality of service providers that provide services using biometric authentication; storing information of the service provider that the user has selected; and enabling the user, at the time of selecting the service provider from which the user desires to receive the service, to distinguish between a service provider that has already been selected by the user and a service provider that has not yet been selected.

### Advantageous Effects of Invention

The individual aspects of the present invention provide a server apparatus, a system, a control method of a server apparatus, and a storage medium, which contribute to enabling a user to grasp the status of each business operator that provides services using biometric authentication. It should be noted that the advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operation of an example embodiment.

FIG. 3 is a diagram illustrating an example of a schematic configuration of an authentication system according to a first example embodiment.

FIG. 4 is a diagram illustrating an operation of the authentication system according to the first example embodiment.

FIG. 5 is a diagram illustrating the operation of the authentication system according to the first example embodiment.

FIG. 6 is a diagram illustrating the operation of the authentication system according to the first example embodiment.

FIG. 7 is a diagram illustrating the operation of the authentication system according to the first example embodiment.

FIG. 8 is a diagram illustrating an example of a processing configuration of a control server according to the first example embodiment.

FIG. 9 is a diagram illustrating an example of an account management database according to the first example embodiment.

FIG. 10 is a diagram illustrating an example of a display of a terminal according to the first example embodiment.

FIG. 11 is a diagram illustrating an example of the display of the terminal according to the first example embodiment.

FIG. 12 is a flowchart illustrating an example of an operation of the control server according to the first example embodiment.

FIG. 13 is a flowchart illustrating an example of the operation of the control server according to the first example embodiment.

FIG. 14 is a diagram illustrating an example of a processing configuration of a service server according to the first example embodiment.

FIG. 15 is a diagram illustrating an example of a user management database according to the first example embodiment.

FIG. 16 is a diagram illustrating an example of a processing configuration of an authentication terminal according to the first example embodiment.

FIG. 17 is a diagram illustrating an example of a processing configuration of the terminal according to the first example embodiment.

FIG. 18 is a diagram illustrating an example of the display of the terminal according to the first example embodiment.

FIG. 19 is a sequence diagram illustrating an example of the operation of the authentication system according to the first example embodiment. 15

FIG. 20 is a diagram illustrating an example of the operation of the authentication system according to the first example embodiment.

FIG. 21 is a diagram illustrating an example of a display of the terminal according to a variation of the first example embodiment.

FIG. 22 is a diagram illustrating an operation of the authentication system according to a second example embodiment.

FIG. 23 is a diagram illustrating an example of a display of the terminal according to the second example embodiment.

FIG. 24 is a diagram illustrating the operation of the authentication system according to the second example embodiment.

FIG. 25 is a diagram illustrating an operation of the authentication system according to a third example embodiment.

FIG. 26 is a diagram illustrating the operation of the authentication system according to the third example embodiment.

FIG. 27 is a flowchart illustrating an example of the operation of the authentication system according to the third example embodiment.

FIG. 28 is a diagram illustrating the operation of the authentication system according to the third example embodiment.

FIG. 29 is a sequence diagram illustrating an example of the operation of the authentication system according to the third example embodiment.

FIG. 30 is a diagram illustrating an operation of the authentication system according to a variation of the third example embodiment.

FIG. 31 is a diagram illustrating an operation of the authentication system according to a fourth example embodiment.

FIG. 32 is a diagram illustrating an example of a display of the terminal according to the fourth example embodiment.

FIG. 33 is a diagram illustrating an example of a display of the terminal according to a fifth example embodiment.

FIG. 34 is a diagram illustrating an example of the display of the terminal according to the fifth example embodiment.

FIG. 35 is a diagram illustrating an example of the display of the terminal according to the fifth example embodiment.

FIG. 36 is a diagram illustrating an example of the display of the terminal according to the fifth example embodiment.

FIG. 37 is a diagram illustrating an example of a hardware configuration of a control server of the present application disclosed.

FIG. 38 is a diagram illustrating an example of a display of the terminal according to a variation of the present application disclosed.

FIG. 39 is a diagram illustrating an example of a schematic configuration of the authentication system according to the variation of the present application disclosed.

FIG. 40 is a diagram illustrating an example of a schematic configuration of the authentication system according to the variation of the present application disclosed.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

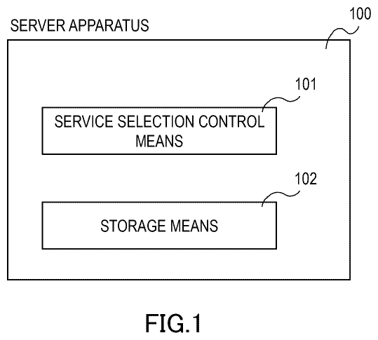

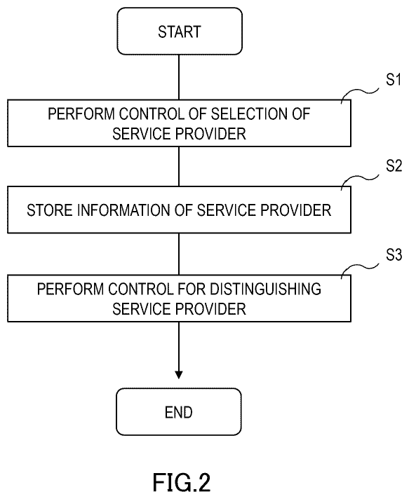

A server apparatus 100 according to an example embodiment includes a service selection control means 101 and a storage means 102 (see FIG. 1). The service selection control means 101 enables a user to select a service provider, the service provider being one from which the user desires to receive a service, from among a plurality of service providers that provide services using biometric authentication (step S1 in FIG. 2). The storage means 102 stores information of the service provider that the user has selected (step S2). The service selection control means 101 enables the user, at the time of selecting the service provider from which the user desires to receive the service, to distinguish between a service provider that has already been selected by the user and a service provider that has not yet been selected (step S3).

In a case where the user selects a service provider from among a plurality of service providers that the user desires to receive a service, the server apparatus 100 displays, for example, a service provider that has already been selected by the user and a service provider that has not yet been selected, in a distinguishable manner, on a terminal of the user. As a result, the user is able to grasp the status of each service provider that provides a service using biometric authentication. That is, the user is able to accurately recognize a service provider that holds own biometric information (a selected service provider) and a service provider that does not hold biometric information (a non-selected service provider).

Hereinafter, specific example embodiments will be described in more detail with reference to drawings.

### First Example Embodiment

A first example embodiment will be described in more detail with reference to drawings.

### [System Configuration]

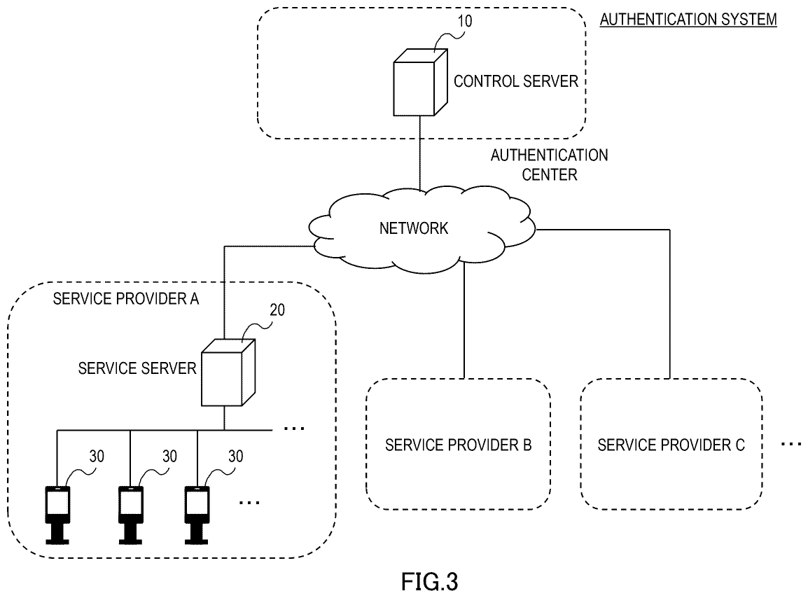

FIG. 3 is a diagram illustrating an example of a schematic configuration of an authentication system (information processing system) according to a first example embodiment. As illustrated in FIG. 3, the authentication system includes a plurality of service providers A to C and an authentication center.

The service provider is a business operator that provides a service to a user by using biometric authentication. In an authentication system according to the present application, it is assumed that service providers belonging to various business types or fields provide services by using biometric authentication. It should be noted that the services provided by the service providers may be either paid or free of charge.

For example, business operators that provide rental housing services such as apartments, business operators that are workplaces of employees (workplaces of users), business operators that provide events such as concerts, and business operators that operate transportation means such as aircraft are examples of the service providers. Alternatively, business operators that provide accommodation services, business operators such as retail stores, business operators that provide financial services, and educational business operators are also included as service providers in the present application disclosed. In addition, the service providers are not limited to private business operators. A public institution such as a local government may also serve as a service provider.

The authentication center is an entity that performs control, management, or the like related to biometric authentication for each of a plurality of service providers. The business operator (service provider) that desires to provide services using biometric authentication to users (general consumers) needs to enter into a contract with the authentication center.

The authentication center includes a control server 10. The control server 10 achieves main functions of the authentication center. The control server 10 may be installed within a building of the authentication center, or may be a server installed on a network (cloud).

As described above, the service provider provides services to users using biometric authentication. For example, biometric authentication is performed in a case where the user goes to the office or returns to an apartment, and the user (an employee, a resident) who has a legitimate qualification is allowed to enter the office or the like. Alternatively, biometric authentication is performed in procedures such as ticket verification at an event venue or the like, check-in procedures at a hotel, and immigration procedures at an airport. Even in such services (procedures), the service is provided to the user who has a legitimate qualification. Alternatively, a payment procedure at a retail store or the like is performed using biometric authentication.

As illustrated in FIG. 3, each service provider includes a service server 20 and at least one or more authentication terminals 30. Apparatuses (service server 20 and authentication terminal 30) provided by the service provider are connected to each other for mutual communication. Specifically, the service server 20 and authentication terminal 30 are connected by wired or wireless communication means.

The service server 20 is connected to the control server 10 via a network. The service server 20 may be located in a building of the service provider or in a cloud.

The service server 20 stores information necessary to provide services to users. Specifically, the service server 20 stores business information necessary for each service provider to provide services using biometric authentication and information necessary for biometric authentication. The service server 20 stores the business information and the information necessary for biometric authentication using a user management database. Details of the user management database are described below.

For example, the service server 20 of a company where the user works stores, as the business information, information such as the user's (employee's) name, date of birth, employee number, department, and work location. In addition, the service server 20 of an event company that hosts an event stores, as the business information, information related to tickets purchased by event participants. Furthermore, the service server 20 of the retail store or the like stores, as business information, credit card information or the like necessary for payment settlement.

Details of information necessary for biometric authentication stored in the service server 20 will be described later.

The authentication terminal 30 is an apparatus that functions as an interface for users who receive services. The authentication terminals 30 are installed at each service provider's respective service locations. More specifically, the authentication terminals 30 are installed in stores or other locations that users actually visit.

The authentication terminal 30 has functions and forms appropriate to the service provider's type of business and other factors. For example, the authentication terminal 30 installed at a workplace or event venue may be a gate apparatus equipped with a gate that restricts passage of the user (person to be authenticated). In addition, a tablet-type terminal may be used as the authentication terminal 30 installed at a retail store.

The configuration illustrated in FIG. 3 is an example and does not limit the configuration or the like of the authentication system disclosed in the present application. For example, the authentication center may include two or more control servers 10. In addition, the authentication system only needs to have at least one or more service providers participating. Furthermore, each service provider only needs to include at least one or more service servers 20 and at least one or more authentication terminals 30.

### [Outline of Operation]

Next, a schematic operation in the authentication system according to the first example embodiment will be described.

### <Account Generation>

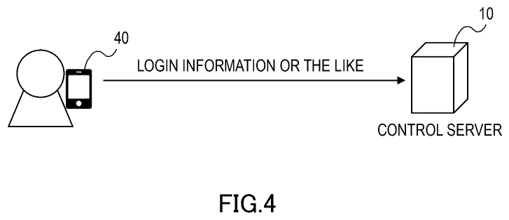

A user who wishes to receive a service from a service provider needs to generate an account in the system. Specifically, the user operates a terminal 40 possessed by the user to access the control server 10 (see FIG. 4).

The user enters login information (for example, a login ID and a password), name, date of birth, and the like on a web page or the like provided by the control server 10. In a case where the control server 10 acquires the login information or the like, the control server 10 generates an ID for identifying the user. It should be noted that, in the following description, the ID generated by the control server 10 is referred to as a “system ID.” The control server 10 stores, in an account management database, the generated system ID in association with the login information or the like. Details of the account management database will be described below.

### <Registration of Biometric Information>

Users who wish to receive services using biometric authentication need to register their biometric information with terminals 40.

Here, for a service using biometric authentication to be provided, authentication information generated from biometric information needs to be registered in advance with the service provider. For example, in a case where a service is provided using face recognition, a feature value (a feature vector) generated from a face image needs to be registered in advance as authentication information. Alternatively, in a case where a service is provided using fingerprint authentication, a feature value generated from a fingerprint image needs to be registered in advance as authentication information.

In the following descriptions, information that serves as an original source (basis) for generating authentication information, such as face images and fingerprint images, will be referred to as “original biometric information”. A feature value that are generated from the original biometric information and pre-registered will be referred to “registered authentication information”.

The user who has completed account generation needs to register original biometric information (for example, a face image) in the terminal 40 possessed by the user. The terminal 40 acquires the original biometric information using a graphical user interface (GUI) or other means. The terminal 40 stores the acquired original biometric information (for example, face image) internally. In this manner, the terminal 40 stores the original biometric information, which is original authentication information used for biometric authentication.

### <Selection of Service>

The user who has performed system registration (account creation) and registration of original biometric information selects a service provider from which the user desires to receive a biometric authentication service. The user selects a service provider, from among a plurality of service providers participating in the authentication system (service providers that have entered into a contract with the authentication center), from which the user desires to receive a service.

The control server 10 stores information on service providers participating in the authentication system. For example, the control server 10 stores a name, type of business, location, and the like of a service provider. The control server 10 holds information on each of the plurality of service providers and enables selection of a service provider by the user.

In a case where the user operates the terminal 40 and performs a predetermined operation on a portal site, the control server 10 displays, on the terminal 40, a GUI or the like that enables selection of a desired service (service provider) by the user. The control server 10 acquires a service (biometric authentication service) desired by the user using the GUI.

### <User Registration>

In a case where the service provider selected by the user is acquired, the control server 10 performs control related to “user registration,” which enables the selected service provider to provide a service using biometric authentication to the user.

Specifically, the control server 10 performs control for allowing the above selected service provider to acquire original biometric information stored in the terminal 40 of the user. The service provider generates registered authentication information from the acquired original biometric information and, by associating the generated registered authentication information with business information, becomes ready to provide a service to the user.

Here, as described above, there are various types of service providers depending on their business category and business model. In the present application disclosed, the service providers participating in the authentication system are classified into four types.

A service provider that belongs to a first type is a business operator that does not have an account (portal site) for managing users to whom services are provided, and repeatedly uses the same business information. For example, a service provider such as a small-scale company (the user's workplace company) or an apartment management company belongs to the first type.

A service provider that belongs to a second type is a business operator that does not have an account (portal site) for managing users to whom services are provided and, in principle, uses business information necessary for authentication only once. For example, a service provider that outsources ticket sales to another company (such as a ticket sales company) and operates an amusement park or a theme park, or a service provider that organizes events such as concerts, belongs to the second type.

A service provider that belongs to a third type is a business operator that has an account (portal site) for managing users (customers) to whom services are provided and repeatedly uses the same business information. For example, a service provider such as a retail business operator that sells products belongs to the third type.

A service provider that belongs to a fourth type is a business operator that has an account (portal site) for managing users to whom services are provided and, in principle, uses business information necessary for authentication only once. For example, a business operator that sells tickets on the own company and operates an amusement park, a theme park, or the like, or an event company that organizes events such as concerts, belongs to the fourth type.

The control server 10 performs user registration control in accordance with the type of service provider selected by the user. In the first example embodiment, “user registration” related to the first type described above will be described below.

### <User Registration for the First Type>

The user operates the terminal 40 to access the control server 10 and logs into the portal site for the user. In a case where the user performs a predetermined operation (for example, pressing a selection button for a service provider) on the portal site, the control server 10 displays a GUI including a list of service providers on the terminal 40.

In a case where the user selects one service provider from among the service providers listed on the terminal 40, the control server 10 acquires, as necessary, information for designating the service provider that is to be subjected to user registration. For example, the control server 10 acquires, from the user, a “management code” designating a company at which the user works or a management company of the apartment building in which the user resides, using a GUI or the like. That is, the user operates the terminal 40 to input the management code.

In a case where the service provider to be subjected to user registration is specified by the management code, the control server 10 determines the type of the specified service provider. In the first example embodiment, the control server 10 determines that a service provider of the first type has been selected.

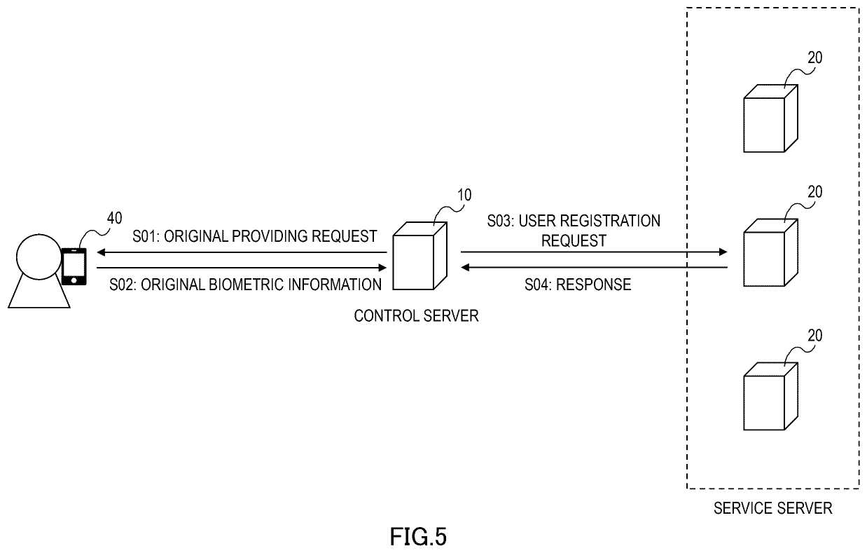

In a case where the service provider is specified, the control server 10 requests the user to provide original biometric information. Specifically, the control server 10 transmits an “original providing request” to the terminal 40 of the user (see step S01 in FIG. 5).

In a case where the original providing request is received, the terminal 40 transmits original biometric information of the user (for example, a face image) to the control server 10 (step S02).

The control server 10 notifies the service provider (a service provider of the first type) selected by the user of the system ID of the user, the acquired original biometric information, personal identification information, and the like. It should be noted that the personal identification information is information for identifying the user. As examples of the personal identification information, the name of the user or a combination of the name and the date of birth of the user is illustrated. Alternatively, an employee number, a room number in an apartment building, or the like may be used as the personal identification information.

The control server 10 transmits a “user registration request” including the system ID, the original biometric information, the personal identification information, and the like to the service server 20 of the service provider selected by the user (step S03).

The service server 20, which has received the user registration request, searches the user management database using the acquired personal identification information and identifies the user who desires user registration (provision of a service using biometric authentication). The service server 20 stores, in the entry of the identified user, the system ID and registration authentication information (for example, a feature value) acquired from the original biometric information.

The service server 20 transmits a response including a result of the user registration (success of the user registration or failure of the user registration) to the control server 10 (step S04).

In this manner, the user provides the original biometric information (master data of biometric information) stored in the terminal 40 such as a smartphone to a service provider via the control server 10 of the authentication center. At that time, the terminal 40 continues to retain, internally, the original biometric information (master data) of the user.

It should be noted that the control server 10 deletes the original biometric information (for example, a face image) acquired from the user at the timing of transmitting the user registration request to the service server 20 or at the timing of receiving a response to the request. In addition, the service server 20 deletes the original biometric information acquired from the control server 10 after generating registration authentication information (for example, a feature value).

### <Provision of Service>

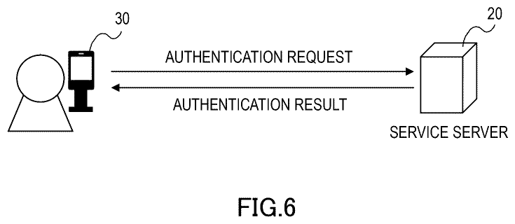

After completing the selection of service, a user visits a service provider to receive service. For example, the user visits a facility, store, or the like of the service provider that the user receives a service, such as an office, amusement park, event venue, retail store, or the like. The authentication terminal 30 acquires the biometric information of a user (a person to be authenticated) to whom the service is provided. For example, the authentication terminal 30 captures an image of the person to be authenticated and acquires biometric information (for example, a face image) corresponding to the original biometric information. The authentication terminal 30 transmits an authentication request including the acquired face image to the service server 20 (see FIG. 6). The authentication terminal 30 transmits other information (for example, payment information such as a price for purchased products) together with the biometric information to the service server 20, if necessary. Alternatively, the authentication terminal 30 may transmit, together with the biometric information (information for identifying an individual, an ID), information used for authentication processing (for example, credit card information) to the service server 20.

The service server 20 generates the authentication information for matching from the acquired face image. For example, the service server 20 generates feature value for matching from the face image. The service server 20 performs a matching process (1-to-N matching; N is a positive integer, the same applies hereinafter) using the generated authentication information for matching (hereinafter referred to as “matching authentication information”) and registered authentication information registered in the user management database.

The service server 20 identifies a user (a person to be authenticated) registered in the user management database by the matching process.

The service server 20 authenticates the user using business information of the identified user. For example, the service server 20 of a company where the employee works determines “authentication success” in a case where the person to be authenticated is an employee of the company and is qualified to enter the office. Alternatively, the service server 20 installed at an event venue determines “authentication success” in a case where the ticket purchased by the person to be authenticated is valid. Alternatively, the service server 20 installed at a retail store determines “authentication success” in a case where the payment for a purchased product or the like by the person to be authenticated is successfully completed.

The service server 20 authentication result (authentication success, authentication failure) to the authentication terminal 30.

The authentication terminal 30 executes a process according to the result of authentication. For example, in a case where authentication success is received, the authentication terminal 30 installed at the office opens a gate and allows the person to be authenticated to pass through the gate. Alternatively, the authentication terminal 30 installed at the event venue allows the person to be authenticated to pass through the gate in a case where authentication success is received. Alternatively, the authentication terminal 30 installed at the retail store notifies the person to be authenticated that payment for the product has been completed in a case where authentication success is received.

### <Cancellation of User Registration>

The user is able to cancel the user registration with respect to a service provider for which the user has performed user registration in order to receive a service.

The user operates the terminal 40 to access the control server 10 and logs into the portal site for the user. In a case where the user performs a predetermined operation (for example, pressing a cancellation button for a service provider) on the portal site, the control server 10 displays, on the terminal 40, a GUI including a list of service providers.

In a case where the user selects, from among the service providers listed on the terminal 40, a service provider for which user registration has already been completed, the control server 10 performs control related to cancellation of the user registration for the selected service provider.

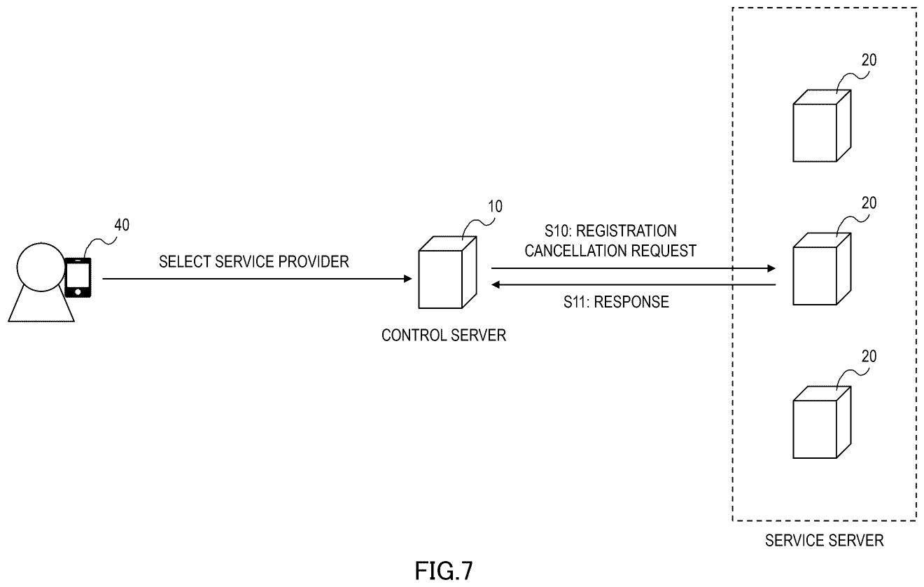

In a case where the service provider for which user registration cancellation is to be performed is selected, the control server 10 transmits, to the service server 20 of the selected service provider, a “registration cancellation request” including the system ID of the user (step S10 in FIG. 7).

The service server 20 searches the user management database using the system ID as a key and specifies the user who desires user registration cancellation (opt-out). The service server 20 deletes at least the system ID and the registered authentication information of the specified user from the user management database.

The service server 20 transmits, to the control server 10, a response to the registration cancellation request (step S11). Specifically, in a case where deletion of the system ID and the registered authentication information is successful (in a case where opt-out is successful), the service server 20 transmits, to the control server 10, a positive response indicating that fact. In a case where deletion of the system ID and the registered authentication information fails (in a case where opt-out fails), the service server 20 transmits, to the control server 10, a negative response indicating that fact.

The control server 10 notifies the user of a result of processing for the registration cancellation request (success of the user registration cancellation or failure of the user registration cancellation).

Next, details of the individual apparatuses included in the authentication system according to the first example embodiment will be described.

### [Control Server]

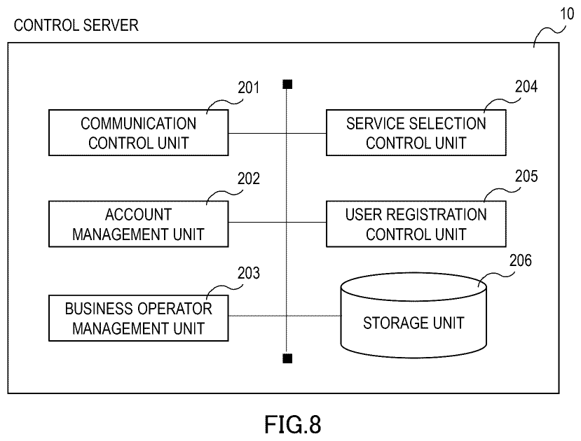

FIG. 8 is a diagram illustrating an example of a processing configuration (processing modules) of the control server 10 according to the first example embodiment. Referring to FIG. 8, the control server 10 includes a communication control unit 201, an account management unit 202, a business operator management unit 203, a service selection control unit 204, a user registration control unit 205, and a storage unit 206.

The communication control unit 201 is means for controlling communication with other apparatuses. Specifically, the communication control unit 201 receives data (packets) from the service server 20. In addition, the communication control unit 201 transmits data to the service server 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The account management unit 202 is means for managing accounts of users. The account management unit 202 acquires information necessary for generating an account of the user, in a case where the user operates the terminal 40 to access a predetermined homepage or the like.

Specifically, the account management unit 202 acquires personal information such as login information, name, date of birth, and so on. After acquiring the login information and the like, the account management unit 202 generates a system ID for identifying the user. The system ID may be any type of information as long as the system ID can uniquely identify the user. For example, the account management unit 202 may assign a unique value each time an account is created and use the assigned value as the system ID.

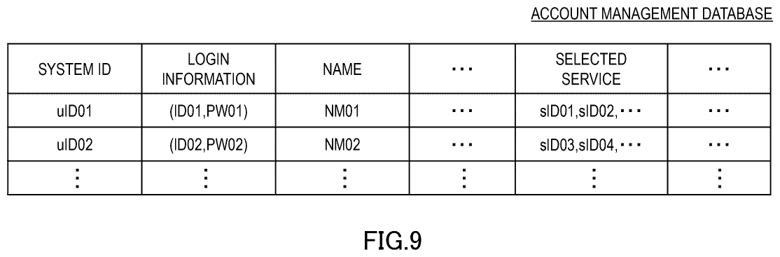

The account management unit 202 stores, in the account management database, the generated system ID, login information, name, and the like in association with each other (see FIG. 9). The configuration illustrated in FIG. 9 is an example, and is not meant to limit items to be stored. For example, the account creation date and time may be stored in the account management database.

In addition, the account management unit 202 acquires login information for logging into a portal site from the terminal 40 of the user. The account management unit 202 performs authentication using the login information.

The business operator management unit 203 is means for managing service providers (service business operators) that participate in the authentication system. The business operator management unit 203 acquires business operator information for system registration from a staff member of each service provider, the information including (the name of the service provider, business type, address, management code, address of the service server 20, and the like). The business operator information may include the type of each service provider (the above-described first through fourth types of service providers).

For example, the business operator management unit 203 may provide each service provider with an interface for entering the business operator information and other information. Alternatively, each service provider may send to the authentication center a USB (Universal Serial Bus) memory or the like in which the business operator information or the like is stored. The business operator management unit 203 may acquire the business operator information or the like from a staff member or the like of the authentication center.

The business operator management unit 203 generates an ID (business operator ID) for a service provider that has acquired business operator information and the like. The business operator management unit 203 associates and stores the generated business operator ID, the acquired business operator information, and so on.

The service selection control unit 204 is means for controlling selection of a biometric authentication service (service provider) by a user. The service selection control unit 204 enables the user to select a service provider from among a plurality of service providers that provide a service using biometric authentication, the selected service provider being one from which the user wishes to receive the service.

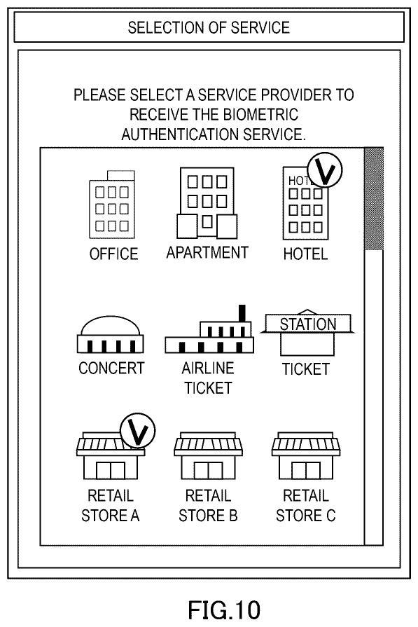

In a case where the user operates the terminal 40 to log into a portal site and performs a predetermined operation on the portal site, the service selection control unit 204 displays, for example, a GUI such as that shown in FIG. 10 on the terminal 40.

In a case where the above-described GUI is displayed, the service selection control unit 204 performs a display that enables a user to distinguish between a service provider that has already been selected and a service provider that has not yet been selected. In the example of FIG. 10, a service provider with a check mark in the upper right of an icon representing a service business operator indicates a service provider that has already been selected, and a service provider without a check mark indicates a service provider that has not yet been selected. In this manner, the service selection control unit 204 enables the user to distinguish between a service provider that has already been selected by the user and a service provider that has not yet been selected by the user, in a case where the user selects a service provider from which the user desires to receive a service.

It should be noted that the service selection control unit 204 uses the business operator information and the information registered in the account management database in order to display the GUI such as that shown in FIG. 10. Specifically, the service selection control unit 204 refers to the business operator information and generates a list of service providers that have entered into a contract with the authentication center. In addition, the service selection control unit 204 refers to a selected service field in the account management database and acquires a service provider (business operator ID of the service provider) that has already been selected by the user.

In addition, the service selection control unit 204 may also provide the user with more detailed information on each service provider (for example, type of business, provided service, store location, and the like) in the case of displaying the list of service providers.

Here, there exist a large number of companies that serve as workplaces of users and apartment management companies, and it is not realistic to display a list of all such companies and management companies. Therefore, the service selection control unit 204 may display an icon that represents a plurality of service providers. In the example of FIG. 10, a plurality of companies (workplaces) are displayed as “office”, and a plurality of apartment management companies are displayed as “apartment”

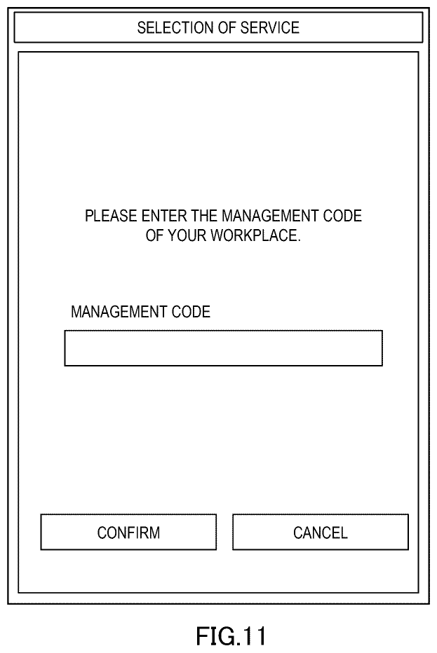

The service selection control unit 204 acquires a management code of a service provider to be subjected to user registration in a case where an icon representing a plurality of service providers has been selected (for example, in the case where an “office” icon or an “apartment” icon has been pressed in the example of FIG. 10). Specifically, the service selection control unit 204 acquires the management code using a GUI as shown in FIG. 11. It should be noted that the user acquires the management code of the user's own company or residential apartment from a workplace, a management company, or the like.

The service selection control unit 204 identifies the service provider selected by the user based on the management code. In this manner, the service selection control unit 204 identifies the service provider selected (designated) by the user by acquiring, from the terminal 40 as necessary, the management code corresponding to the service provider from which the user desires to receive a service.

It should be noted that, in a case where an icon that does not represent the plurality of service providers (an icon directly indicating a service provider; for example, icons for retail stores A to C in FIG. 10) is pressed, the service selection control unit 204 is able to identify the service provider selected by the user without using a management code. The service selection control unit 204 passes information of the service provider selected by the user (for example, a business operator ID of the service provider for which user registration is requested) to the user registration control unit 205.

In addition, the service selection control unit 204 enables cancellation of a service provider already selected by the user (termination of receiving a service from the service provider). Specifically, in a case where the user performs a predetermined operation on the portal site, the service selection control unit 204 displays a GUI as shown in FIG. 10.

In FIG. 10, in a case where a service provider already registered by the user (a service provider with a check mark in the upper right corner in the example of FIG. 10) is selected, the service selection control unit 204 performs control for canceling the user registration for the selected service provider. It should be noted that the service selection control unit 204 acquires, as necessary, the management code of the service provider whose user registration is to be canceled.

The service selection control unit 204 passes information of the service provider selected by the user (the service provider for which cancellation of user registration has been requested) to the user registration control unit 205.

The user registration control unit 205 is means for controlling “user registration” by the control server 10. For example, the user registration control unit 205 performs control to allow the service provider selected by the user to acquire original biometric information, which serves as the original source of authentication information used for biometric authentication, by using a predetermined code (management code).

The user registration control unit 205 controls the “user registration” that enables a service provider selected by the user to provide the user with a service using biometric authentication. Alternatively, the user registration control unit 205 controls cancellation of user registration.

The user registration control unit 205 performs user registration control in accordance with the type of service provider for which user registration has been requested. The user registration control unit 205 acquires the type of the selected service provider from the business operator information. In the first example embodiment, a case where a service provider of the first type has been selected will be described below. That is, the user registration control unit 205 performs user registration control to allow a service provider, the service provider being selected by the user and not having accounts for managing customers, to acquire original biometric information of a user, which serves as original source of authentication information to be used for biometric authentication.

In a case where the user registration control unit 205 acquires information of the service provider selected by the user from the service selection control unit 204, the user registration control unit 205 transmits an “original providing request” to the terminal 40 possessed by the user. The user registration control unit 205 receives original biometric information of the user (for example, a face image) from the terminal 40.

The user registration control unit 205 transmits a user registration request, including the user's system ID, original biometric information, personal identification information, and the like, to the service server 20 of the service provider corresponding to the service selected by the user.

It should be noted that the user registration control unit 205 acquires the system ID and personal identification information (for example, a name or a combination of a name and a date of birth) from the account management database.

The user registration control unit 205 receives a response to the user registration request (positive response, negative response).

In a case where a positive response (successful user registration) is received, the user registration control unit 205 registers the business operator ID of the service provider selected by the user in the account management database. In addition, in a case where the positive response is received, the user registration control unit 205 notifies the user that the user registration for the selected service provider has been successfully completed.

In a case where a negative response (failed user registration) is received, the user registration control unit 205 notifies the user of that fact.

In a case where cancellation of user registration is requested, the user registration control unit 205 transmits a “registration cancellation request” including the system ID of the user to the service server 20 of the service provider for which cancellation has been requested.

The user registration control unit 205 receives a response (positive response, negative response) to the registration cancellation request. The user registration control unit 205 notifies the user of a result of the registration cancellation request.

Specifically, in a case where a positive response (registration cancellation success) is received, the user registration control unit 205 notifies the user of that fact. For example, the user registration control unit 205 notifies that the user registration for the service provider selected by the user has been canceled by removing a check mark from the icon shown in FIG. 10. Alternatively, in a case where the registration cancellation is successful, the user registration control unit 205 may display a message or the like indicating that the registered authentication information (for example, a feature value) has been deleted from the service provider (the service server 20). That is, the terminal 40 may report to the user that the feature value registered in the service server 20 has been deleted due to the registration cancellation. In a case where a negative response (registration cancellation failure) is received, the user registration control unit 205 notifies the user of that fact.

In addition, the user registration control unit 205 reflects information of the service provider for which user registration cancellation (opt-out) has been successfully performed in the account management database. The user registration control unit 205 deletes the business operator ID of the service provider for which user registration cancellation has been successfully performed from the selected service field of the account management database.

Alternatively, the account management database may store a history of user registration of the user registration and cancellation of the user registration. In this case, the user registration control unit 205 stores, in the account management database, a business operator ID of a service provider that was registered by the user through user registration (opt-in) and was then canceled through cancellation of the user registration (opt-out) (for example, stores the business operator ID in a canceled service field).

The storage unit 206 is means for storing information necessary for the operation of the control server 10. The storage unit 206 stores, using the account management database, information of the service provider selected by the user (a business operator ID of the service provider selected by the user).

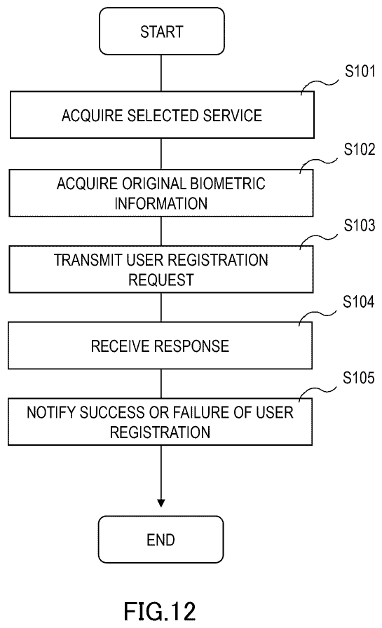

With respect to user registration, the operation of the control server 10 described above is summarized in the flowchart shown in FIG. 12.

The control server 10 acquires a biometric authentication service (a service provider) desired by the user (acquires a selected service; step S101). At that time, the control server 10 acquires, as necessary, a management code of the service provider.

The control server 10 acquires original biometric information by transmitting an “original providing request” to the terminal 40 possessed by the user (step S102).

The control server 10 transmits, to the service server 20, a user registration request including a system ID, the acquired original biometric information (for example, a face image), and a piece of personal identification information (for example, a name) (step S103).

The control server 10 receives a response to the user registration request from the service server 20 (step S104).

The control server 10 notifies the user of the success or failure of the user registration (step S105).

In this manner, the control server 10 acquires original biometric information by requesting the terminal 40 possessed by the user to provide the original biometric information, and transmits the acquired original biometric information to the service server 20 of the service provider selected by the user. At that time, the control server 10 transmits at least the system ID for managing users in the own apparatus and the acquired original biometric information to the service server 20.

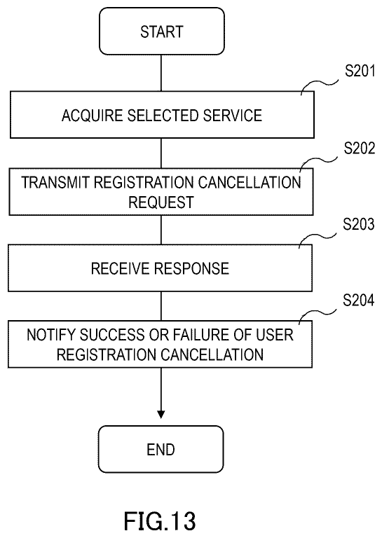

Furthermore, with respect to cancellation of user registration, the operation of the control server 10 described above is summarized in the flowchart shown in FIG. 13.

The control server 10 acquires a biometric authentication service (a service provider) for which the user desires registration cancellation (acquires a selected service; step S201).

The control server 10 transmits a registration cancellation request including a system ID to the service server 20 of the above-selected service provider (step S202).

The control server 10 receives a response to the registration cancellation request from the service server 20 (step S203).

The control server 10 notifies the user of the success or failure of the user registration cancellation (step S204).

### [Service Server]

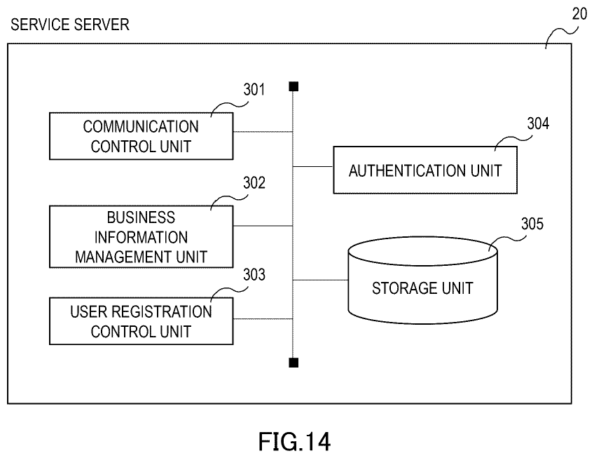

FIG. 14 is a diagram illustrating an example of a processing configuration (processing modules) of the service server 20 according to the first example embodiment. As illustrated in FIG. 14, the service server 20 includes a communication control unit 301, a business information management unit 302, a user registration control unit 303, an authentication unit 304, and a storage unit 305.

The communication control unit 301 is means for controlling communication with other apparatuses. For example, the communication control unit 301 receives data (packets) from the control server 10. In addition, the communication control unit 301 transmits data to the control server 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The business information management unit 302 is means for managing and controlling business information necessary for a service provider to provide business.

The business information management unit 302 acquires the business information necessary to provide own service by any means. For example, the business information management unit 302 of a user's employer acquires, as business information, information such as the employee's name, date of birth, employee number, department, and work location.

The business information management unit 302 may acquire the above business information from a staff member or the like of the service provider, or may directly acquire the business information from the user using means such as a webpage or the like.

The business information management unit 302 manages the business information using the user management database.

It should be noted that a more detailed description of the business information management unit 302 will be omitted. This is because the details of business information in individual services and the method of acquiring such information are different from a purpose of the present application.

The user registration control unit 303 is means for controlling user registration by the service provider. The user registration control unit 303 processes a user registration request received from the control server 10.

In a case where a user registration request is received, the user registration control unit 303 searches the user management database using, as a key, personal identification information (for example, a name) included in the user registration request, and identifies a corresponding user (entry).

In a case where a corresponding user is registered in the user management database, the user registration control unit 303 generates registered authentication information from the acquired original biometric information (for example, a face image). For example, in a case where a face image is acquired, the user registration control unit 303 generates, as registered authentication information, a feature value (a feature vector) corresponding to a face recognition algorithm adopted by the own company.

Since an existing technology can be used to generate the feature values, a detailed description thereof will be omitted. For example, the user registration control unit 303 extracts eyes, nose, mouth, and the like as feature points from the face image. Next, the user registration control unit 303 calculates the location of an individual feature point and the distance between feature points as the feature values and generates the feature vector formed by a plurality of feature values (vector information that characterizes the face image).

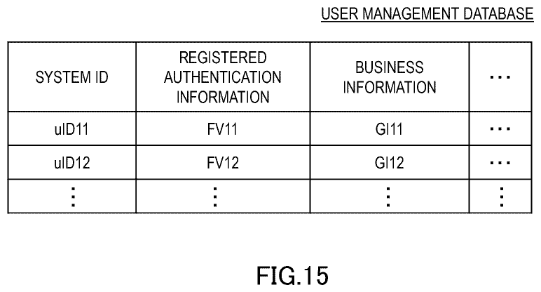

In a case where the registered authentication information (for example, a feature value) is generated, the user registration control unit 303 associates and stores the system ID, the generated registered authentication information (feature value), and the business information in the user management database (see FIG. 15).

It should be noted that the user management database shown in FIG. 15 is an example, and is not meant to limit the items to be stored. For example, the date and time of user registration may be registered in the user management database.

In a case where user registration is successfully completed, the user registration control unit 303 transmits a positive response indicating successful user registration to the control server 10. It should be noted that, after generating registered authentication information (for example, a feature value) and registering the generated registered authentication information in the user management database, the user registration control unit 303 deletes the original biometric information acquired from the control server 10.

In a case where the user registration is not successfully completed, the user registration control unit 303 transmits a negative response indicating failure of the user registration to the control server 10. For example, the negative response is transmitted to the control server 10 in a case where the personal identification information (for example, a name) received from the control server 10 is not registered in the user management database, or in a case where valid registered authentication information cannot be generated from the original biometric information, or the like.

Furthermore, the user registration control unit 303 processes a registration cancellation request received from the control server 10.

In a case where the registration cancellation request is received, the user registration control unit 303 searches a user management database using, as a key, the system ID included in the registration cancellation request, and identifies a corresponding user. The user registration control unit 303 deletes at least the system ID and the registered authentication information (for example, a feature value) of the identified user. Alternatively, the user registration control unit 303 deletes the entry of the identified user (an entry in the user management database), as necessary.

In a case where deletion of the system ID and the like is successful, the user registration control unit 303 transmits a positive response indicating that the user registration cancellation has been successfully performed to the control server 10. In a case where the cancellation of user registration fails due to reasons such as the system ID acquired from the control server 10 not being present in the user management database, the user registration control unit 303 transmits a negative response indicating that fact to the control server 10.

The authentication unit 304 is means for performing a biometric authentication of a person to be authenticated. The authentication unit 304 receives an authentication request from the authentication terminal 30. The authentication unit 304 extracts biometric information (for example, a face image) from the authentication request.

The authentication unit 304 generates matching authentication information from the acquired biometric information. For example, upon acquiring a face image, the authentication unit 304 generates feature value corresponding to a face authentication algorithm employed by the own company. The authentication unit 304 performs a matching processing using the generated matching authentication information (feature value) and the registered authentication information (feature value) in the user management database.

Specifically, the authentication unit 304 calculates a similarity between the feature value (the feature vector) as the matching target and each of a plurality of feature values registered. As the similarity, a chi-square distance, a Euclidean distance, or the like can be used. A longer distance represents a lower similarity, and a shorter distance represents a higher similarity.

If there are no feature value whose similarity is greater than a predetermined value, the authentication unit 304 sets an authentication result to “authentication failure”.

If there is feature value whose similarity is greater than a predetermined value, the authentication unit 304 identifies the entry (user) with the most similar feature value (registered authentication information) among the plurality of entries registered in the user management database. The authentication unit 304 authenticates the person to be authenticated using the business information of the identified user.

For example, the authentication unit 304 of the user's workplace determines “authentication success” in a case where the user identified through matching processing is an employee of the own company and is qualified to enter the office. Alternatively, the authentication unit 304 determines “authentication failure” in a case where the identified user is an employee of the own company but is not qualified to enter the location where the authentication terminal 30 is installed.

It should be noted that a more detailed description of authentication processing using business information in each service provider will be omitted. This is because the processing specific to each service provider is different from the purpose of the present application.

The authentication unit 304 transmits an authentication result (authentication success, authentication failure) to the authentication terminal 30.

The storage unit 305 is means for storing information necessary for the operation of the service server 20.

It should be noted that a service provider belonging to the first type, in principle, continues to store business information used for authentication of the user. For example, the service server 20 continues to store the business information until an employee resigns or a resident moves out. In other words, the service server 20 may delete the business information in response to an event such as an employee's resignation.

### [Authentication Terminal]

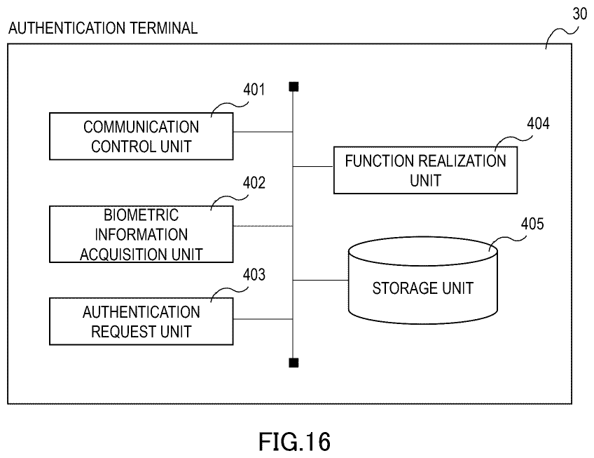

FIG. 16 is a diagram illustrating an example of a processing configuration (processing modules) of the authentication terminal 30 according to the first example embodiment. As illustrated in FIG. 16, the authentication terminal 30 includes a communication control unit 401, a biometric information acquisition unit 402, an authentication request unit 403, a function realization unit 404, and a storage unit 405.

The communication control unit 401 is means for controlling communication with other apparatuses. Specifically, the communication control unit 401 receives data (packets) from the service server 20. In addition, the communication control unit 401 transmits data to the service server 20. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The biometric information acquisition unit 402 controls a camera and acquires biometric information (for example, face image) of a person to be authenticated. The biometric information acquisition unit 402 takes images of the front of the apparatus periodically or at predetermined times. The biometric information acquisition unit 402 determines whether the acquired image includes a human face image, and if the human face image is included, extracts the face image from the acquired image data.

An existing technique can be used for the face image detection and extraction processing performed by the biometric information acquisition unit 402, and therefore, detailed description thereof will be omitted. For example, the biometric information acquisition unit 402 may extract a face image (a face area) from the image data by using a learning model learned by a CNN (Convolutional Neural Network). Alternatively, the biometric information acquisition unit 402 may extract a face image by using a technique such as template matching.

The biometric information acquisition unit 402 passes the extracted face image to the authentication request unit 403.

The authentication request unit 403 is means for requesting the service server 20 to perform an authentication of a person to be authenticated. In a case where authentication of the person to be authenticated becomes necessary, the authentication request unit 403 transmits an authentication request including the biometric information of the person to be authenticated (the user in front of the authentication terminal 30) to the service server 20.

The authentication request unit 403 receives an authentication result (authentication success, authentication failure) from the service server 20. The authentication request unit 403 passes the received authentication result to the function realization unit 404.

The function realization unit 404 is means for realizing a function assigned to the authentication terminal 30. For example, in a case where the authentication terminal 30 is installed at the workplace of the user, the function realization unit 404 of the authentication terminal 30 opens a gate and permits entry of the person to be authenticated upon receiving an authentication success.

A more detailed description of the function realization unit 404 included in the authentication terminal 30 of each service provider will be omitted. This is because function realization of the authentication terminal 30 by the function realization unit 404 is different from the purpose of the present application.

The storage unit 405 is means for storing information necessary for the operation of the authentication terminal 30.

### [Terminal]

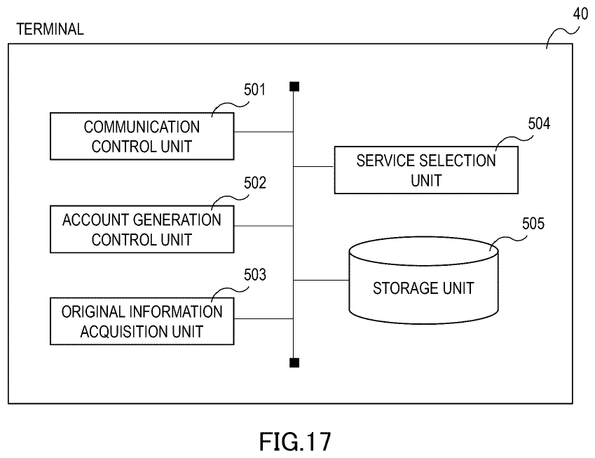

FIG. 17 is a diagram illustrating an example of a processing configuration (processing modules) of the terminal 40 according to the first example embodiment. As illustrated in FIG. 17, the terminal 40 includes a communication control unit 501, an account generation control unit 502, an original information acquisition unit 503, a service selection unit 504, and a storage unit 505.

The communication control unit 501 is means for controlling communication with other apparatuses. For example, the communication control unit 501 receives data (packets) from the control server 10. In addition, the communication control unit 501 transmits data to the control server 10. The communication control unit 501 gives data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes a function as a receiving unit for receiving data from other apparatuses, and a function as a transmitting unit for transmitting data to other apparatuses.

The account generation control unit 502 is means for controlling an account generation by a user. The account generation control unit 502 accesses a predetermined web page or the like provided by the control server 10, in accordance with an operation performed by the user.

The account generation control unit 502 enters login information, name, date of birth, and so on, on the web page in response to the operation of the user.

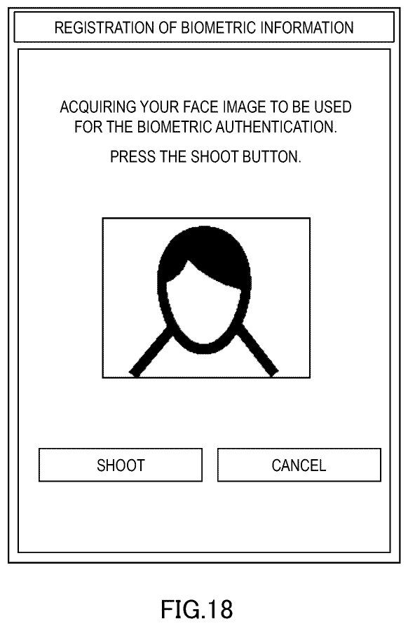

The original information acquisition unit 503 is means for acquiring the biometric information (original biometric information) of a user. The original information acquisition unit 503 displays a GUI, or the like for acquiring the original biometric information (for example, face image) in response to an operation of the user. For example, the original information acquisition unit 503 uses a GUI such as that shown in FIG. 18 to acquire the original biometric information.

The original information acquisition unit 503 stores the acquired original biometric information (for example, a face image) in the storage unit 505. At that time, the original information acquisition unit 503 may perform encryption, encoding, or the like on the acquired original biometric information and store the encrypted original biometric information in the storage unit 505. That is, the terminal 40 possessed by the user may hold the encrypted original biometric information. The encrypted original biometric information may be decrypted in a case where the original biometric information is transmitted to the control server 10. Alternatively, information for decrypting the encrypted original biometric information (for example, a common key) may be shared between the terminal 40 and the control server 10, and the control server 10 may decrypt the encrypted original biometric information.

It should be noted that, in principle, the terminal 40 does not delete original biometric information (for example, a face image) of the user. That is, the terminal 40 does not delete the original biometric information stored in storage unit 505 without explicit instructions from the user.

The service selection unit 504 is means for enabling a user to select a biometric authentication service. The service selection unit 504 logs into a portal site provided by the control server 10, in accordance with an operation performed by the user. The service selection unit 504 transmits information of a service provider selected by the user to the control server 10 by using a GUI provided by the control server 10.

The service selection unit 504 receives an original providing request from the control server 10. In a case where the request is received, the service selection unit 504 transmits the original biometric information stored in the storage unit 505 to the control server 10.

The storage unit 505 is means for storing information necessary for the operation of the terminal 40.

### [System Operation]

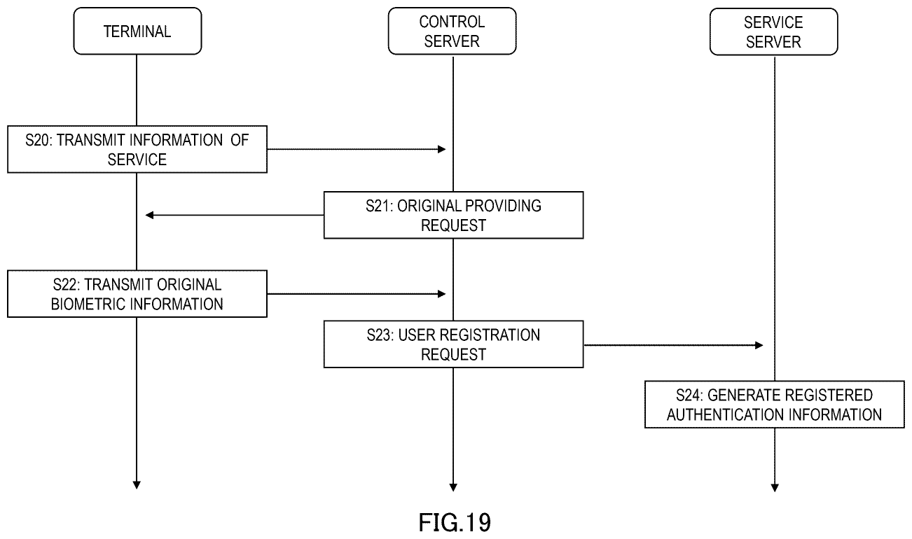

Next, operations in the authentication system according to the first example embodiment will be described. It should be noted that description of operations related to account generation and the like will be omitted. FIG. 19 is a sequence diagram illustrating an example of the operation related to user registration in the authentication system according to the first example embodiment.

The terminal 40 transmits, to the control server 10, information of a service selected by the user (information of a service provider from which the user desires to receive a biometric authentication service) (transmits service information; step S20).

In a case where the user selects a service that the user desires to receive, the control server 10 transmits an original providing request to the terminal 40 of the user (step S21).

In response to receiving the original providing request, the terminal 40 transmits original biometric information (for example, a face image) to the control server 10 (step S22).

The control server 10 transmits a user registration request including a system ID, the acquired original biometric information, personal identification information, and the like, to the service server 20 of the service provider selected by the user (step S23).

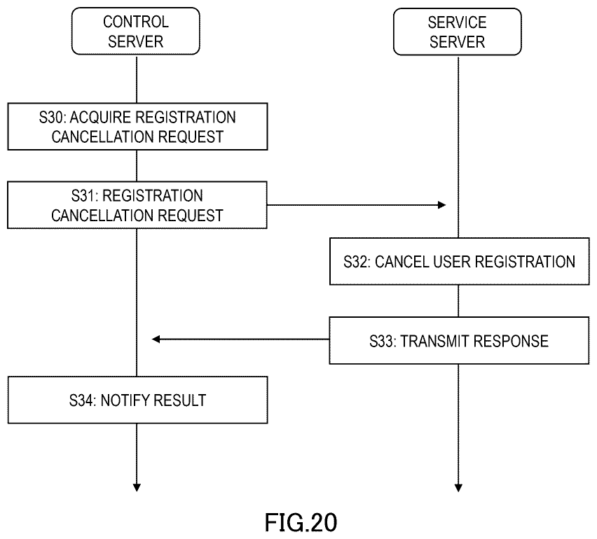

The service server 20 generates authentication information for registration (registered authentication information) from the acquired original biometric information (step S24). The generated registered authentication information is registered in the user management database. Next, an operation related to cancellation of user registration in the authentication system according to the first example embodiment will be described below. FIG. 20 is a sequence diagram illustrating an example of the operation of the authentication system according to the first example embodiment.

The control server 10 acquires information of a service provider for which the user desires registration cancellation (acquires a registration cancellation request; step S30).

In a case where a service provider to be subjected to user registration cancellation is designated, the control server 10 transmits a registration cancellation request including a system ID of the user to the service server 20 of the designated service provider (step S31).

The service server 20 cancels user registration of the user by deleting, from the user management database, the registered authentication information and the system ID corresponding to the system ID (step S32).

The service server 20 transmits a response (positive response, negative response) to the registration cancellation request to the control server 10 (step S33).

The control server 10 notifies the user of a result of the user registration cancellation in accordance with the received response (step S34).

### Variation 1 According to the First Example Embodiment

In the above described example embodiment, a case is described in which the management code input by the user is used to identify the service provider selected by the user from among a plurality of service providers. However, the management code may also be used as information indicating whether or not the user is qualified to select the service provider. Specifically, the management code may be used as proof that the user is qualified to register a service provider (such as a workplace or an apartment management company).

For example, in a case where the user selects a workplace or an apartment management company or the like as a service provider, the control server 10 displays, on the terminal 40, a list of workplaces or the like that have entered into a contract with the authentication center. In a case where the user selects a workplace or an apartment management company or the like from among the displayed list, the control server 10 prompts the user to input a management code corresponding to the selected workplace or the like.

The control server 10 determines that the user is qualified to receive a service from the service provider in a case where the management code of the service provider selected by the user matches the management code input by the user. On the other hand, the control server 10 determines that the user is not qualified to receive a service from the service provider in a case where the management code of the service provider selected by the user does not match the management code input by the user. In a case where the user is qualified to receive a service from the service provider, the control server 10 accepts user registration (selection of the service provider) for the user. In this manner, the service selection control unit 204 requests the user to input a first management code in a case where the user selects a service provider from which the user desires to receive a service. The service selection control unit 204 accepts the selection of a service provider by the user in a case where a first management code input by the user matches a predetermined second management code corresponding to the service provider selected by the user.

For example, in a case where the user selects workplace A and inputs the correct management code of workplace A, the control server 10 determines that the user is qualified to perform user registration with workplace A. In this manner, the control server 10 may use a management code as a password. By using the management code as a password, the control server 10 can prevent user registration by a user who is unrelated to the service provider.

### Variation 2 According to the First Example Embodiment

In the first example embodiment, the control server 10 (the service selection control unit 204) has been described as displaying, on the terminal 40, a service provider that has already been selected and a service provider that has not yet been selected in a distinguishable manner, as shown in FIG. 10. That is, the control server 10 displays, on the terminal 40, a service provider that has already been selected by the user (an opted-in service provider) and a service provider that has not yet been selected by the user (a service provider not opted in) in a distinguishable manner.

The control server 10 may perform, on the terminal 40, a display that allows the user to grasp details of the above-mentioned service provider that has not yet been selected. Specifically, the control server 10 may display, in a distinguishable manner, a service provider that has never been selected by the user and a service provider for which the user registration has been canceled at least one or more times after being registered (an opted-out service provider).

The control server 10 treats a service provider corresponding to a business operator ID that is set in the selected service field of the account management database as a “service provider that has already been selected.” The control server 10 also treats a service provider corresponding to a business operator ID that is set in the canceled service field of the account management database as a “service provider for which user registration has been canceled.” The control server 10 treats a service provider that is not set in either of the fields (the selected service field or the canceled service field) as a “service provider that has never been selected.”

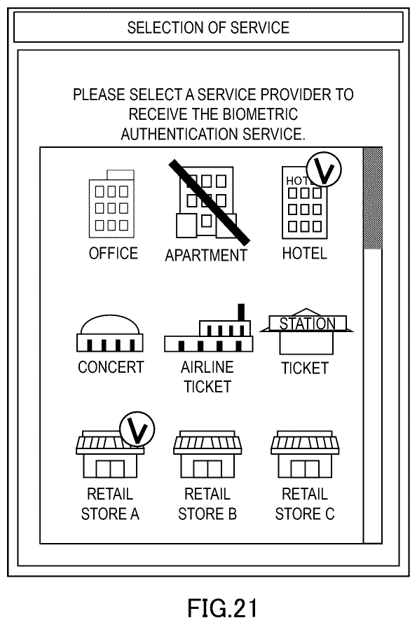

The control server 10 may display, on the terminal 40, the above three statuses of the service provider at the time the user selects a service or at the time the user selects a service to be canceled. For example, the control server 10 may perform a display on the terminal 40 as shown in FIG. 21.

In FIG. 21, a service provider that has already been selected is indicated by placing a check mark in the upper right corner of the icon, and a service provider for which user registration has been canceled is indicated by placing diagonal lines across the entire icon. In addition, a service provider corresponding to an icon that has neither a check mark nor diagonal lines indicates a service provider that has never been selected.

It should be noted that the control server 10 may distinguish among the above three statuses of the service provider using any desired method or mode. For example, the control server 10 may change the color of an icon or cause the icon to blink. Alternatively, the control server 10 may display a message indicating the above three statuses. For example, the control server 10 may display the status of the service provider corresponding to the icon (displayed in text) in a case where the user touches the icon.

In this manner, the storage unit 206 further stores information (a business operator ID) of a service provider whose selection has been canceled by the user. The service selection control unit 204 performs control to enable the user to distinguish three statuses of the service provider in a case where the user selects a service provider from which the user desires to receive a service. Specifically, the service selection control unit 204 enables the user to distinguish among a service provider that has already been selected by the user, a service provider that has never been selected by the user, and a service provider whose selection has been canceled by the user.

As described above, the control server 10 according to the first example embodiment displays, on the terminal 40 of the user, a service provider that has already been selected by the user and a service provider that has not yet been selected, in a distinguishable manner (see, for example, FIG. 10). As a result, the user is able to grasp the status of each business operator that provides services using biometric authentication. That is, the user is able to accurately recognize a service provider that holds the user's own biometric information (a selected service provider) and a service provider that does not hold the biometric information (an unselected service provider).

In addition, the control server 10 according to the first example embodiment performs control for allowing a service provider belonging to the first type to acquire original biometric information that serves as the original source of authentication information used for biometric authentication. A service provider belonging to the first type is a service provider that does not have an account for managing customers and repeatedly uses business information to provide services to customers. In order to enable such a service provider to acquire original biometric information of a user (customer), the control server 10 transmits, to the service server 20 of the service provider, the original biometric information of the user along with personal identification information (for example, a name). The service server 20 identifies the user using the personal identification information, and stores, in association, registered authentication information and business information of the identified user. By completing such association, the service provider becomes capable of providing services to the user using biometric authentication.

In addition, in the authentication system according to the first example embodiment, original biometric information necessary for biometric authentication (for example, a face image) is stored in the terminal 40 of the user. In a case where the user desires to receive a biometric authentication service, after the user selects a service provider, the original biometric information stored in the terminal 40 is provided to the selected service provider (a service provider that requires registered authentication information). By registering the user's own biometric information (for example, a face image) in the terminal 40 once, the user is able to receive each service (at various service provision locations) without registering the biometric information with each individual service. That is, if the user captures the user's own face once, the user is able to use face recognition services at various locations (services) without performing face registration again using the face image. In other words, by registering biometric information once, it is possible to apply the biometric information to various solutions using biometric authentication.

In addition, by means of the above configuration, various problems that occur in a case where a service provider provides a biometric authentication service are resolved. In conventional systems, the service provider was required to have the user register a face image for each service provision location (service). However, in the system according to the first example embodiment, it is sufficient for the user to perform face registration only once, and the burden on the service provider to guide the user to register a face image is significantly reduced. In addition, the service provider is not required to hold original biometric information (a face image), and the burden on the service provider with respect to information leakage or the like is reduced. In particular, in a case where the same service provider adopts a plurality of face recognition algorithms, it is no longer necessary to hold face images corresponding to each face recognition algorithm, and therefore the management risk of the service provider is reduced. Further, in a case where the authentication center stores original biometric information under the consent of the user, the service provider is able to change the face recognition engine adopted by the own company or newly adopt a face recognition engine suitable for the provided service. That is, the service provider is not limited to a specific vendor's face recognition engine and is able to adopt various vendors' face recognition engines suitable for the intended use. As a result, the service provider can avoid a business risk of excessively depending on a single vendor (a single face recognition engine). That is, a service provider that participates in the authentication system disclosed in the present application is able to easily support multiple vendors.

In addition, from the user's perspective, the convenience for the user is improved because it is not necessary to register a face image multiple times even for the same service (the same service provider). Furthermore, since the original biometric information (a face image) is retained in the user's own terminal 40 and the user's own face image is not held by an external company or the like, concerns about information leakage or the like are reduced. That is, the user is able to enjoy biometric authentication services with a sense of security.

### Second Example Embodiment

Next, a second example embodiment will be described in detail with reference to drawings.

In the second example embodiment, user registration related to a service provider of the second type will be described.

It should be noted that, as a configuration of the authentication system according to the second example embodiment can have the same configuration as that according to the first example embodiment, the description corresponding to FIG. 3 will be omitted. In addition, as a processing configuration of the control server 10 or the like according to the second example embodiment can have the same processing configurations as that according to the first example embodiment, description thereof will be omitted.

The following description will be made with a focus on the difference between the first example embodiment and the second example embodiment.

As described above, a service provider belonging to the second type (for example, an operating company of an amusement park or the like, or an event company for a concert or the like) does not provide a portal site to the user. The event company stores, as business information, ticket information that the user has purchased via a ticket sales site or the like, and authenticates the user using the business information.

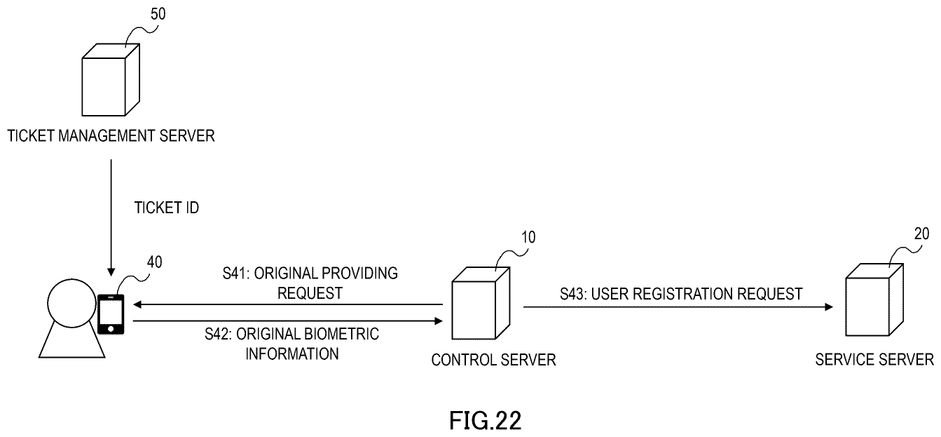

The user operates the terminal 40 to access a ticket sales site and purchases a desired ticket on the ticket sales site. Specifically, as shown in FIG. 22, the user operates the terminal 40 to access a ticket management server 50 and purchases a ticket. The terminal 40 acquires information of the purchased ticket. For example, the terminal 40 acquires, from the ticket management server 50, an ID (a ticket ID) for uniquely identifying the purchased ticket.

It should be noted that detailed description of a configuration of the ticket management server 50, detailed description of ticket purchase, and acquisition of the ticket ID or the like will be omitted. This is because ticket purchase and the like are outside the scope of the present application disclosed and are obvious to those skilled in the art.

The user selects a service provider belonging to the second type in a GUI such as that shown in FIG. 10. For example, the user selects an event company that operates an amusement park, a theme park, or the like. That is, the user operates the terminal 40 to access the control server 10 and selects a service provider to be subjected to user registration. It should be noted that the control server 10 acquires, as necessary, a management code for designating a service provider from the user.

The control server 10 determines the type of the selected service provider based on a business operator ID of the selected service provider. Here, a service provider belonging to the second type is selected. In the business operator information of the service provider belonging to the second type, information related to business information required by the service provider is described. In the above example, the fact that ticket information (a ticket ID) is required is described in the business operator information.

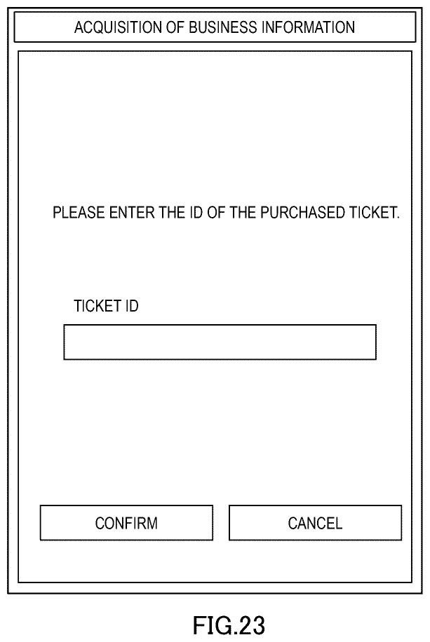

In a case where a service provider of the second type is selected, the user registration control unit 205 of the control server 10 acquires business information required by the service provider. For example, the user registration control unit 205 acquires a ticket ID by displaying, on the terminal 40, a GUI such as that shown in FIG. 23.

In a case where the ticket ID is acquired, the user registration control unit 205, as in the first example embodiment, acquires original biometric information from the terminal 40 of the user by transmitting an original providing request to the terminal 40 (steps S41 and S42 in FIG. 22).

In a case where the original biometric information is acquired, the user registration control unit 205 transmits, to the service server 20 of the service provider selected by the user, a user registration request including a system ID, the above-acquired ticket ID (business information), and the original biometric information (step S43).

The user registration control unit 303 of the service server 20 generates registered authentication information from the acquired biometric information. In addition, the user registration control unit 303 adds a new entry to a user management database and stores, in the added entry, a system ID, the registered authentication information, and the business information (the ticket ID).

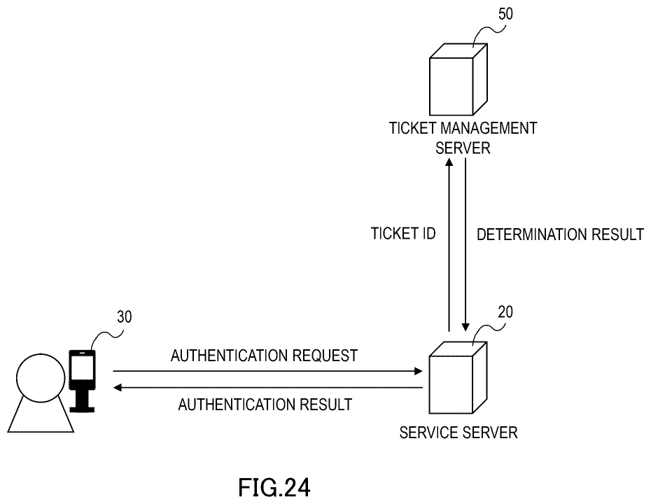

The service server 20 processes an authentication request received from the authentication terminal 30. Specifically, the authentication unit 304 of the service server 20 transmits a ticket ID of the person to be authenticated, which is identified through matching processing, to a ticket management server 50 of a ticket sales site (see FIG. 24).

The ticket management server 50 determines the validity of the acquired ticket ID. Specifically, the ticket management server 50 determines the validity of the ticket based on a location of an event venue, an event date and time, or the like of the ticket specified by the ticket ID. The ticket management server 50 transmits a determination result to the service server 20. The authentication unit 304 determines authentication success in a case where the ticket is valid. The authentication unit 304 determines authentication failure in a case where the ticket is invalid.

It should be noted that, in principle, a service provider belonging to the second type deletes business information that has been used for user authentication. This is because the business information used by the service provider of the second type (business information necessary for the service provider to provide a service to a customer; for example, a ticket ID) is information that is substantially used only once at the time of biometric authentication. For example, in a case where a ticket purchaser enters an event venue, the ticket purchaser is not determined to be authenticated successfully again, and therefore, the corresponding business information is deleted. Alternatively, in a case where reentry to the event venue is permitted, the service server 20 may delete the corresponding business information after the event ends (after a predetermined time has elapsed from the scheduled end time of the event).

In addition, although the above description has been given using tickets for amusement parks, concerts, and the like as examples, it is of course not intended to limit the types of tickets. For example, tickets such as boarding passes and train tickets for transportation systems are also processed in the same manner. Furthermore, the tickets targeted by the present application disclosed include not only tickets that are limited to one-time use but also tickets that are used a plurality of times. For example, tickets having a validity period, such as excursion passes (for example, tickets that allow unlimited use of transportation systems during a predetermined period) and commuter passes, are also within the scope of the present application disclosed.

As described above, the control server 10 of the second example embodiment transmits, in addition to a system ID and original biometric information, business information (such as a ticket ID) necessary for the service provider selected by the user to provide a service using biometric authentication to the user, to the service server 20. As a result, the service provider belonging to the second type is able to acquire business information (for example, a ticket ID) necessary for authenticating the user.

### Third Example Embodiment

Next, a third example embodiment will be described in detail with reference to drawings.

In the third example embodiment, user registration related to a service provider of the third type will be described.

As a configuration of the authentication system according to the third example embodiment can have the same configuration as that according to the first example embodiment, the description corresponding to FIG. 3 will be omitted. In addition, as a processing configuration of the control server 10 or the like according to the third example embodiment can have the same processing configurations as that according to the first example embodiment, description thereof will be omitted.

The following description will be made with a focus on the difference from the first example embodiment to the third example embodiment.

The user selects a service provider belonging to the third type in a GUI such as that shown in FIG. 10. For example, the user selects a retail store such as a convenience store.

It should be noted that a user who selects a service provider belonging to the third type already possesses an account of the selected service provider. For example, a user who wishes to use biometric authentication-based payment at a convenience store is a member of the convenience store and already has an account. In addition, payment information for payment settlement is stored as business information in the account of the convenience store. The payment information includes information related to arbitrary payment methods, such as information related to a credit card, information related to an amount charged to a transportation system IC (Integrated Circuit) card, and information for code-based payment using a two-dimensional barcode.

The control server 10 enables the user to use biometric authentication-based payment by performing control related to user registration for targets such as retail stores including convenience stores. The control server 10 links an account of the service provider selected by the user with an account of the authentication system.

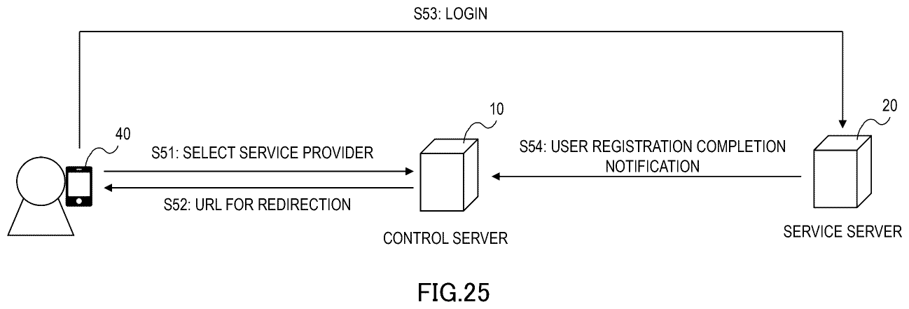

The user operates the terminal 40 to access the control server 10 and selects a service provider to be subjected to user registration (account linkage) (step S51 in FIG. 25).

The control server 10 determines the type of the selected service provider based on a business operator ID of the selected service provider. Here, a service provider belonging to the third type is selected.

In a case where a service provider of the third type is selected, the user registration control unit 205 of the control server 10 transmits, to the terminal 40, a URL (Uniform Resource Locator) for logging into the account of the selected service provider (step S52).

The URL transmitted to the terminal 40 is a URL for redirection for connecting the terminal 40 to the login page of the service provider, and the URL for redirection contains a system ID of the user embedded therein. It should be noted that the URL for redirection is provided in advance to the control server 10 as business operator information. The user registration control unit 205 embeds the system ID (an ID used by the control server 10 to manage users) into the URL for redirection stored as business operator information, and transmits the URL for redirection to the terminal 40.

In a case where the terminal 40 receives the URL for redirection, the terminal 40 accesses the login page of the service provider in accordance with the URL. At that time, since the URL for redirection includes the system ID, the user registration control unit 303 of the service server 20 is able to acquire the system ID of the user.

The user operates the terminal 40 to input login information (login information for logging into the account of the service provider) on the login page of the service provider (step S53).

The user registration control unit 303 of the service server 20 searches the user management database using acquired login information (a user ID) as a key, and identifies a corresponding user. . . . The user registration control unit 303 stores, in an entry of the identified user, a system ID acquired from the URL for redirection. That is, the user registration control unit 303 stores in association a user ID managed by the company (the service provider) and a system ID used by the authentication system to manage users.

In the following description, an ID issued by each service provider to manage users (customers, members, or the like) will be referred to as an “individual ID.” The user registration control unit 303 stores, in association, an individual ID and a system ID of a user who has logged into the portal site in accordance with a URL for redirection (links the IDs).

In a case where the association between the individual ID and the system ID is completed, the user registration control unit 303 may notify the control server 10 of the system ID of the user. For example, the user registration control unit 303 may transmit, to the control server 10, a “user registration completion notification” including the system ID (step S54). The user registration control unit 205 of the control server 10 which has received the user registration completion notification may notify the user that the user registration has been completed.

For example, the control server 10 may notify the user of the completion of user registration by placing a check mark on the icon of the service provider for which user registration has been completed, on a screen such as that shown in FIG. 10.

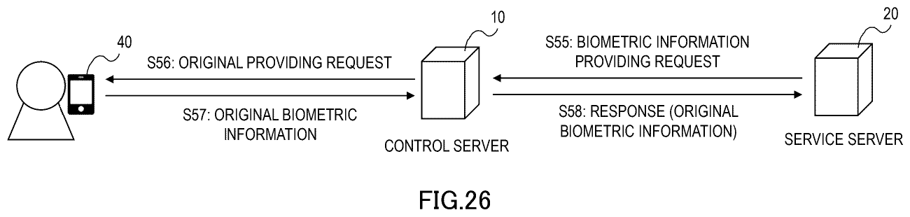

In a case where the association between the individual ID and the system ID is completed, the user registration control unit 303 of the service server 20 transmits a “biometric information providing request” including the system ID of the user to the control server 10 (step S55 in FIG. 26).

In a case where a biometric information providing request is received, the user registration control unit 205 of the control server 10 searches the account management database using a system ID included in the biometric information providing request as a key, and identifies a corresponding user. The user registration control unit 205 transmits an “original providing request” to the terminal 40 of the identified user (step S56).

In response to receiving the original providing request, the terminal 40 transmits original biometric information (for example, a face image) of the user to the control server 10 (step S57).

In a case where the original biometric information is acquired, the user registration control unit 205 transmits the acquired original biometric information (for example, a face image) to the service server 20. Specifically, in a case where the original biometric information is acquired from the terminal 40, the user registration control unit 205 transmits a positive response including the acquired original biometric information to the service server 20 (step S58). It should be noted that, in a case where the original biometric information cannot be acquired from the terminal 40, the user registration control unit 205 transmits a negative response to the service server 20 as a response to the biometric information providing request.

The user registration control unit 303 of the service server 20 generates registered authentication information from the acquired original biometric information and stores the registered authentication information in the user management database. The user registration control unit 303 stores, in the user management database, a system ID, an individual ID (login information), the registered authentication information, and a piece of business information (for example, credit card information) in association with each other.

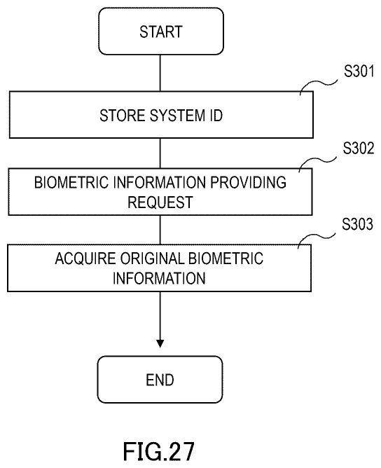

The operation of the authentication system related to user registration, which has been described with reference to FIG. 25 and FIG. 26, is summarized in the flowchart shown in FIG. 27.

In a case where the terminal 40 of the user accesses a login page, the service server 20 acquires a system ID, which has been embedded in a URL for redirection, and stores the acquired system ID internally (step S301).

The service server 20 transmits a biometric information providing request, which includes the system ID, to the control server 10 (step S302). That is, the service server 20 makes a request, via the control server 10, to the terminal 40 for the provision of original biometric information (for example, a face image) of the user.

The service server 20 acquires the original biometric information from the terminal 40 via the control server 10 (step S303). The service server 20 generates face information (registered authentication information; feature value) from the acquired original biometric information, and stores the face information in association with a system ID.

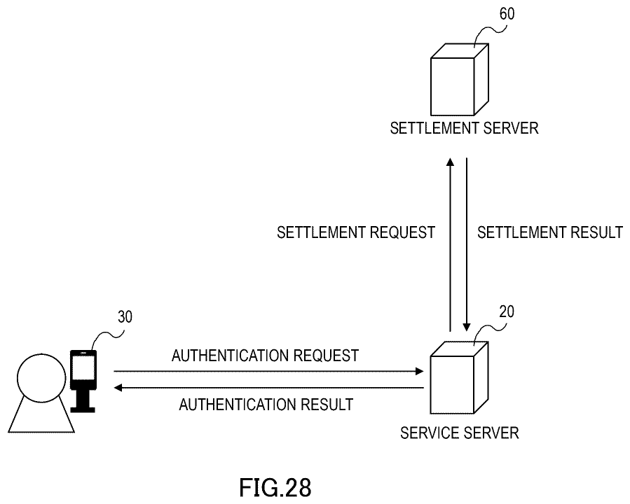

In a case where the user purchases a product at a retail store, the authentication terminal 30 transmits, to the service server 20, an authentication request including biometric information and payment information (purchase price) of the product purchaser (see FIG. 28). The service server 20 identifies a person to be authenticated (the product purchaser) by matching processing using the acquired biometric information.

The service server 20 performs payment processing using credit card information and payment information of the identified person to be authenticated. Specifically, the service server 20 requests the settlement server 60 of the credit card company to perform payment settlement for the product price by transmitting credit card information and payment information to the settlement server 60. The settlement server 60 notifies the service server 20 of a result of the payment processing. It should be noted that a configuration and an operation of the settlement server 60 are outside the scope of the present application disclosed and are apparent to those skilled in the art, and therefore detailed description thereof will be omitted.

In a case where a successful payment is notified, the service server 20 determines authentication success. In a case where a failed payment is notified, the service server 20 determines authentication failure. The service server 20 notifies the authentication terminal 30 of an authentication result.

It should be noted that a service provider belonging to the third type repeatedly uses business information (for example, credit card information) necessary to authenticate a user. Accordingly, even in a case where authentication of the user is successful, the service server 20 does not delete the business information and continues to store the business information.

### [System Operation]

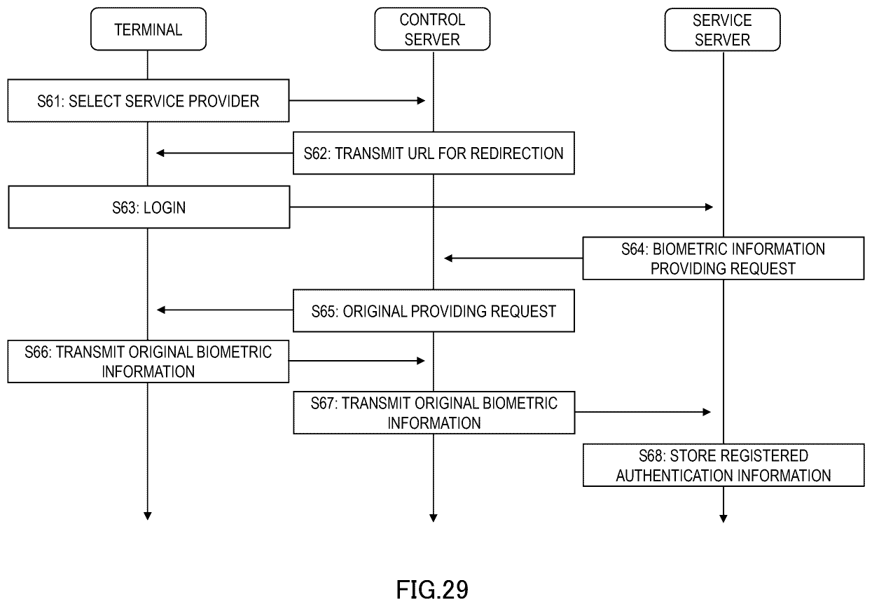

FIG. 29 is a sequence diagram illustrating an example of an operation in the authentication system according to the third example embodiment. Referring to FIG. 29, the operation of the authentication system according to the third example embodiment will be described.

The terminal 40 selects a service provider in accordance with an operation by the user (step S61).

In a case where a service provider belonging to the third type is selected, the control server 10 transmits a URL for redirection to the terminal 40 (step S62).

The terminal 40 accesses a login page indicated by the URL for redirection and logs into the portal site, in accordance with an operation by the user (step S63). At that time, the service server 20 acquires a system ID embedded in the URL for redirection.

The service server 20 identifies the user using login information (an individual ID that the service provider uses to manage users) and transmits a biometric information providing request related to the identified user to the control server 10 (step S64).

The control server 10 transmits an original providing request to the terminal 40 of the user (step S65).

The terminal 40 transmits original biometric information (for example, a face image) to the control server 10 (step S66).

The control server 10 transmits the acquired original biometric information to the service server 20 (step S67).

The service server 20 generates registered authentication information (for example, a feature value) from the acquired original biometric information (for example, a face image), and stores the registered authentication information in the user management database (step S68).

### Variation 1 According to the Third Example Embodiment

In the third example embodiment, it has been described that the service server 20 may transmit a “user registration completion notification” to the control server 10 after account linkage (association between an individual ID and a system ID) has been completed. However, the service server 20 may transmit the user registration completion notification to the control server 10 after the registered authentication information of the user has been registered in the user management database.

### Variation 2 According to the Third Example Embodiment

In a case where the service provider has an account to manage users, as in the third example embodiment, a URL for redirection may be used to cancel user registration of the service provider.

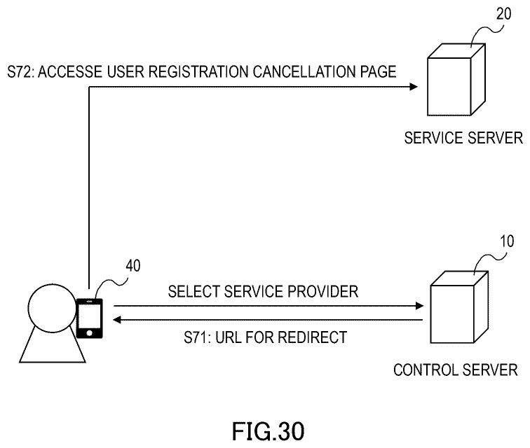

Specifically, in a case where the service provider selected by the user belongs to the third type or to the fourth type, which will be described below, the control server 10 transmits, to the terminal 40, a URL for redirection that redirects a user registration cancellation page of the selected service provider (step S71 in FIG. 30).

The terminal 40 accesses the user registration cancellation page corresponding to the URL for redirection, in accordance with an operation by the user (step S72). The service server 20 of the service provider identifies a user who desires to cancel user registration using an individual ID of the user who has logged in according to the URL for redirection (an individual ID of the user who has logged into the portal site).

The service server 20 deletes a system ID and registered authentication information of the identified user. User registration is canceled by deletion of the system ID and the registered authentication information.

As described above, the control server 10 according to the third example embodiment performs control to acquire original biometric information, which serves as the original source of authentication information used for biometric authentication, for a service provider belonging to the third type. The service provider belonging to the third type is a service provider selected by the user, that has an account to manage users, and that repeatedly uses business information necessary for providing services to customers at the time of biometric authentication. The control server 10 transmits, to the terminal 40 of the user, information for logging into an account of the service provider selected by the user. In response to receiving a biometric information providing request from the service server 20 that manages the account of the user, the control server 10 acquires the original biometric information from the terminal 40 by requesting the terminal 40 to provide original biometric information that serves as the original source of authentication information used for biometric authentication. The control server 10 transmits the acquired original biometric information to the service server 20.

The service provider belonging to the third type has an account (a portal site) to manage users and uses an individual ID to manage the users. At the time of user registration (account linkage, ID linkage), the user logs into a portal site in accordance with a URL for redirection in which a system ID is embedded, and thereby, the service server 20 is able to acquire the system ID and the individual ID of the user at the same timing. In other words, unlike in the first example embodiment, the service server 20 is able to identify the user using the individual ID without using personal identification information, and thus can realize more reliable user registration. That is, personal identification information (for example, a name) may possibly be duplicated, whereas the individual ID is an ID issued to each user by the service server 20, and therefore the possibility of duplication does not exist (the possibility of duplication is extremely low). The service server 20 is able to realize reliable account linkage (ID linkage) by identifying the user using the individual ID. In this manner, in the information processing system according to the third example embodiment, the only information transmitted to the service server 20 via the control server 10 is original biometric information, and personal identification information is not transmitted to the service server 20 via the control server 10. In the third example embodiment, the information for identifying a person (personal identification information) is transmitted to the service server 20 from the terminal 40 that has acquired the URL for redirection. In this way, since the personal identification information is not transmitted from the control server 10 to the service server 20, the security strength of the system is improved.

### Fourth Example Embodiment

Next, a fourth example embodiment will be described in detail with reference to drawings.

In the fourth example embodiment, user registration related to a service provider of the fourth type will be described.

As a configuration of the authentication system according to the fourth example embodiment can have the same configuration as that according to the first example embodiment, the description corresponding to FIG. 3 will be omitted. In addition, as a processing configuration of the control server 10 or the like according to the fourth example embodiment can have the same processing configurations as that according to the first example embodiment, description thereof will be omitted.

The following description will be made with a focus on the difference from the first example embodiment to the fourth example embodiment.

The basic operation of the system according to the fourth example embodiment can be the same as the operation of the system according to the third example embodiment. Specifically, in a case where a service provider belonging to the fourth type is selected, each apparatus included in the authentication system performs the operation shown in FIG. 25.

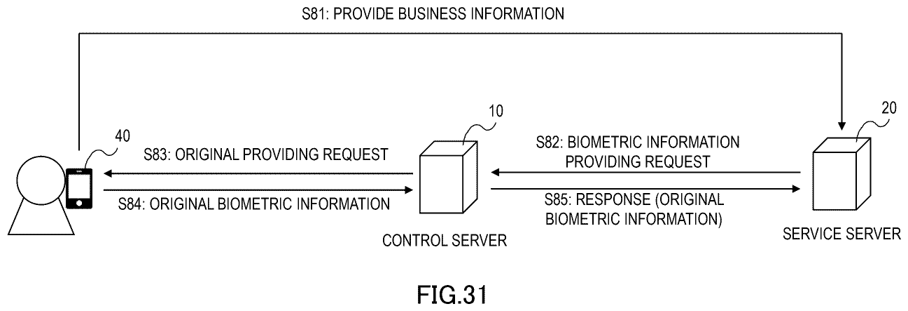

After linkage between the ID of the service provider and the system ID of the authentication system is completed, the user provides business information, which is necessary for receiving the service, to the service provider (step S81 in FIG. 31). For example, the user purchases a ticket for a movie, a concert, an amusement park, an airline, or a transportation ride on the portal site or the like of the service provider into which the user has logged in.

It should be noted that the provision of business information (ticket purchase) may be carried out as part of the procedure in which the user logs into the portal site of the service provider at the time of user registration. Alternatively, after user registration is completed, the user may log out from the portal site. The user may log into the portal site again at a later time in order to purchase a ticket. In this case, the user may operate the terminal 40 to directly access (log into) the portal site.

The service server 20 stores information related to a ticket that has been purchased by the user. The business information management unit 302 of the service server 20 stores, in a user management database, business information (ticket information) that has been provided by the user.

The user registration control unit 303 of the service server 20 accesses the user management database at regular timing or at predetermined timing, and refers to business information (ticket information) of each user. In a case where a predetermined time before the referred-to business information (ticket information) becomes valid is reached (a predetermined time before the referred-to business information is used for authentication processing), the user registration control unit 303 requests the control server 10 to provide biometric information.

Specifically, the user registration control unit 303 transmits, to the control server 10, a biometric information providing request including the system ID of a user (a user who may use a ticket after a predetermined period of time) (step S82).

The control server 10, which has received the biometric information providing request, acquires original biometric information (for example, a face image) by transmitting an original providing request to the terminal 40 (steps S83 and S84). The control server 10 transmits the acquired original biometric information to the service server 20 (step S85).

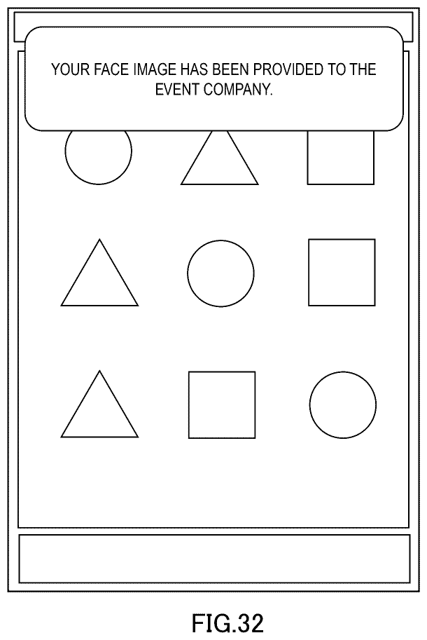

It should be noted that, in the fourth example embodiment, the timing at which the user selects a service provider and the timing at which the original biometric information (a face image) is provided to the service provider are often different. Therefore, the terminal 40 may notify the user, by using a popup notification or the like, of the fact that the original biometric information has been transmitted to the control server 10 (see FIG. 32).

The authentication unit 304 of the service server 20 according to the fourth example embodiment, in a case where an authentication request is received from the authentication terminal 30 that is installed in a location such as an event venue, determines an authentication result in accordance with whether or not a ticket of the user, who has been identified through matching processing, is valid. The authentication terminal 30 permits passage through the gate to a user who has been determined to have achieved authentication success (a user who possesses a valid ticket). The authentication terminal 30 denies passage through the gate to a user who has been determined to have failed authentication (a user who does not possess a valid ticket).

It should be noted that a service provider belonging to the fourth type may delete business information that has been used for user authentication, as in the second example embodiment. The service server 20 according to the fourth example embodiment may retain the account of the user (system ID, individual ID, registered authentication information) without deleting the user account. By retaining the account of the user, even in a case where the user purchases another ticket such as for a different concert from the same service provider, user registration related to the service provider (ID linkage, account linkage) becomes unnecessary.

As described above, the control server 10 according to the fourth example embodiment performs control to acquire original biometric information that serves as the original source of authentication information used for biometric authentication, for a service provider belonging to the fourth type. The service provider belonging to the fourth type is a service provider selected by the user, that has an account to manage customers, and that substantially uses business information necessary to provide services to customers only once at the time of biometric authentication. The control server 10 transmits, to the terminal 40 of the user, information for logging into the account of the service provider selected by the user. In response to receiving a biometric information providing request from the service server 20 that manages accounts of users, the control server 10 acquires the original biometric information from the terminal 40 by requesting the terminal 40 to provide original biometric information that serves as the original source of authentication information used for biometric authentication. The control server 10 transmits the acquired original biometric information to the service server 20. As a result, reliable user registration (account linkage, ID linkage) is achieved also for the service provider belonging to the fourth type. That is, also in the fourth example embodiment, as in the third example embodiment, the information transmitted to the service server 20 via the control server 10 is limited to the original biometric information, and personal identification information is not transmitted to the service server 20 via the control server 10. In the fourth example embodiment, information for identifying an individual (personal identification information) is transmitted to the service server 20 from the terminal 40 that has acquired the URL for redirection. In this way, since the personal identification information is not transmitted from the control server 10 to the service server 20, the security strength of the system is improved.

### Fifth Example Embodiment

Next, a fifth example embodiment will be described in detail with reference to drawings.

In the fifth example embodiment, a case will be described in which, at the time of user registration, the user sets a validity period for registered authentication information (for example, a feature value) provided by the selected service provider.

It should be noted that as a configuration of the authentication system according to the fifth example embodiment can have the same configuration as that according to the first example embodiment, the description corresponding to FIG. 3 will be omitted. In addition, as a processing configuration of the control server 10 or the like according to the fourth example embodiment can have the same processing configurations as that according to the first example embodiment, description thereof will be omitted.

The following description will be made with a focus on the difference from the first example embodiment to the fifth example embodiment.

After the user has selected a service provider, the service selection control unit 204 of the control server 10 determines whether or not the user sets a validity period for the registered authentication information for the selected service provider, and in a case where the validity period is to be set, the service selection control unit 204 acquires the period.

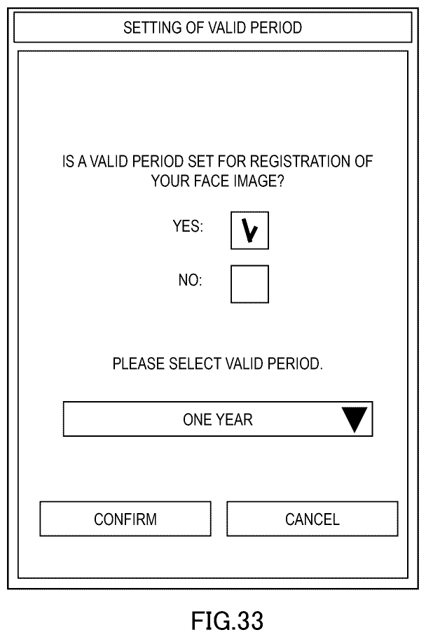

For example, the service selection control unit 204 acquires whether or not a validity period is to be set and the specific period to be set, by using a GUI such as that shown in FIG. 33.

In a case where a validity period has been set, the service selection control unit 204 stores the set validity period (for example, one year) or the expiration date (for example, a date one year later) in the account management database in association with the business operator ID of the selected service provider.

In addition, at the time of user registration, the user registration control unit 205 of the control server 10 notifies the service server 20 of the service provider selected by the user of the above-described validity period (expiration date).

In the case of the first and second example embodiments, the user registration control unit 205 transmits a user registration request including, in addition to the system ID of the user, the original biometric information, and the personal identification information, the above-described validity period (expiration date), to the service server 20.

In the case of the third and fourth example embodiments, the user registration control unit 205 transmits, to the terminal 40, a URL for redirection in which the system ID and the validity period (expiration date) are embedded. The user registration control unit 205 notifies the service provider of the validity period (the period during which the service provider can retain the registered authentication information) by using the URL for redirection through the terminal 40.

In this manner, the service selection control unit 204 according to the fifth example embodiment acquires a validity period of registered authentication information that is generated by a service provider selected by the user at the time the user selects a service provider from which the user desires to receive a service. The user registration control unit 205 transmits the acquired original biometric information and the validity period to the service server 20 of the service provider selected by the user.

The user registration control unit 303 of the service server 20 stores the validity period (expiration date) acquired from the user registration request or the redirect URL in the user management database.

The user registration control unit 303 of the service server 20 accesses the user management database periodically or at a predetermined timing. The user registration control unit 303 deletes at least registered authentication information (for example, a feature value) related to a user whose validity period has expired. Alternatively, the user registration control unit 303 may delete an entry of the user (an entry including registered authentication information, a system ID, business information, or the like) as necessary.

The control server 10 (service selection control unit 204) may provide a user with a service provider for which a validity period is set or information related to the validity period, in a case where the user selects a service provider or the like.

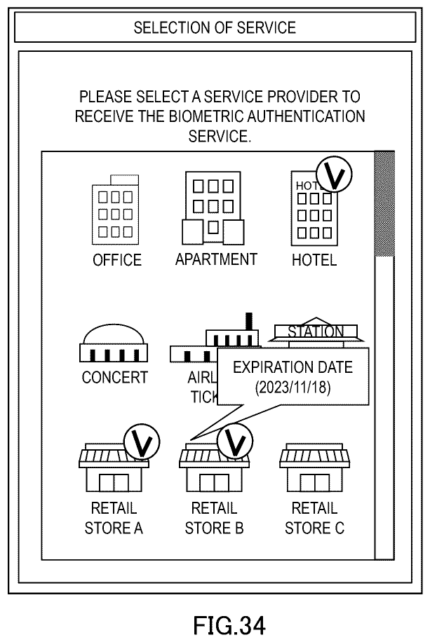

For example, the service selection control unit 204 may display a service provider for which a validity period is set in a manner distinguishable from other service providers. Alternatively, the service selection control unit 204 may display, as shown in FIG. 34, an indication that a validity period is set for a service provider along with an expiration date.

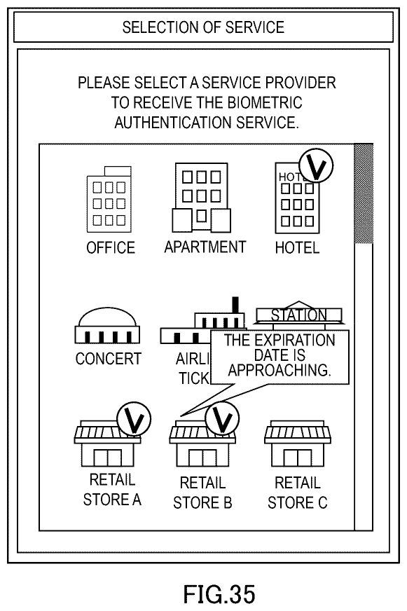

Alternatively, the service selection control unit 204 may perform a display that gives a warning indicating that a remaining validity period is short, related to a service provider whose expiration date is approaching (for example, a service provider for which only one week remains in the validity period) (see FIG. 35).

In this manner, the storage unit 206 may further store information of a service provider for which a validity period is set in registered authentication information. The service selection control unit 204 may display, on the terminal 40 possessed by a user, a message corresponding to the validity period, related to a service provider for which a validity period is set in registered authentication information.

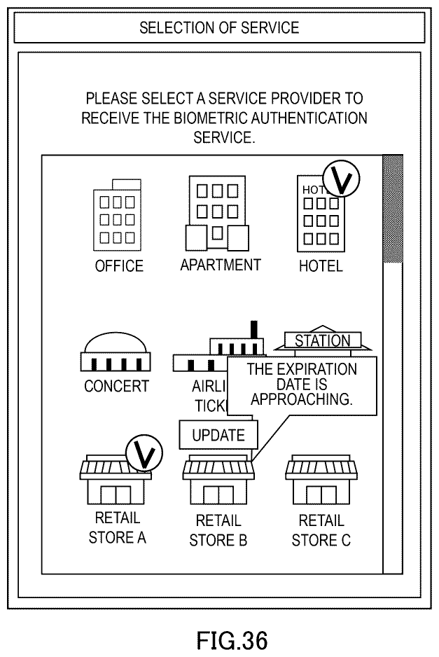

Alternatively, the service selection control unit 204 may provide a user with an interface for updating the validity period, related to a service provider whose remaining validity period is short. For example, the service selection control unit 204 may place an “update button” near an icon corresponding to a service provider for which a warning related to the validity period has been issued (see FIG. 36).

It should be noted that, in FIGS. 34 to 36, a check mark at the upper right indicating that service selection has already been performed may be illustrated on an icon corresponding to a retail store B for which a validity period is set.

In a case where the update button is pressed, the service selection control unit 204 acquires, by a GUI similar to FIG. 33, whether or not the validity period is to be set again, and in a case where the validity period is to be set, the period thereof.

In a case where a user desires to update the validity period, the user registration control unit 205 transmits a “validity period update instruction” including a system ID and a validity period (expiration date) of the user to the service server 20 of a service provider. The user registration control unit 303 of the service server 20 updates the validity period (expiration date) of the user corresponding to the acquired system ID based on information included in the validity period update instruction.

Alternatively, the user registration control unit 205 may acquire original biometric information (for example, a face image) from the user (the terminal 40) who desires to update the validity period. In this case, the user registration control unit 205 may transmit a validity period update instruction including the acquired original biometric information, a system ID, and a validity period (expiration date) to the service server 20.

In this manner, the service selection control unit 204 may acquire, from a user, an update instruction related to a validity period of a service provider for which a validity period is set in registered authentication information. At that time, the user registration control unit 205 transmits a validity period update instruction including an updated validity period to the service server 20 of a service provider for which the validity period update has been instructed. Alternatively, the user registration control unit 205 may transmit a validity period update instruction including an updated validity period and original biometric information of a user to the service server 20 of a service provider for which the validity period update has been instructed.

As described above, a control server 10 according to the fifth example embodiment manages a service provider based on three statuses and notifies a user of a status of the service provider. As a result, the user is able to select a service provider with reference to the notified status. In addition, the control server 10 is able to meet more specific demands of the user by enabling setting of a validity period during which a service provider is able to retain biometric information (for example, a feature value).

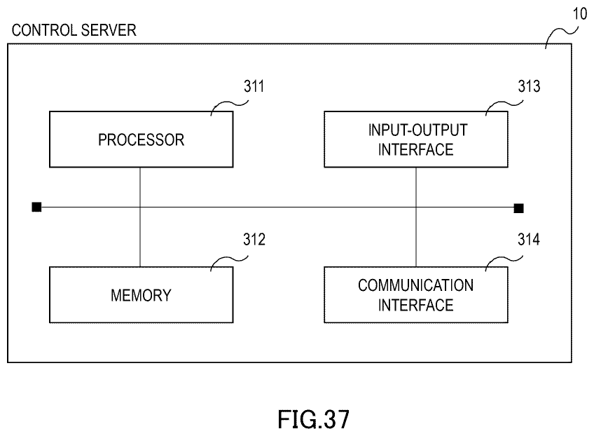

Next, a hardware configuration of an individual apparatus that constitutes the authentication system will be described. FIG. 37 is a diagram illustrating an example of a hardware configuration of the control server 10.

The control server 10 can be configured by an information processing apparatus (a so-called computer) and has a configuration illustrated as an example in FIG. 37. For example, the control server 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 37 is not intended to limit the hardware configuration of the control server 10. The control server 10 may include hardware not illustrated in the figure, and may omit the input-output interface 313 as needed. In addition, the number of components such as the processor 311 included in the control server is not intended to be limited to the example shown in FIG. 37, and, for example, a plurality of processors 311 may be included in the control server 10.

The processor 311 is, for example, a programmable device such as a CPU (Central Processing Unit), an MPU (Micro Processing Unit), a DSP (Digital Signal Processor), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like that performs communication with other apparatuses. For example, the communication interface 314 includes a NIC (Network Interface Card) or the like.

The functions of the control server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the service server 20, the authentication terminal 30, the terminal 40, and the like can also be configured by information processing apparatuses in the same manner as the control server 10, and since the specific hardware configurations of the service server 20, the authentication terminal 30, the terminal 40, and the like are not different from that of the control server 10, a detailed description thereof will be omitted. For example, it is sufficient for the authentication terminal 30 to include a camera apparatus for capturing an image of the person to be authenticated.

The control server 10, which is an information processing apparatus, is equipped with a computer, and the functions of the control server 10 can be realized by causing the computer to execute a program. In addition, the control server 10 executes a control method of the control server 10 by using the program. Similarly, the terminal 40, which is an information processing apparatus, includes a computer and can realize its functions by causing the computer to execute a program. In addition, the terminal 40 executes a terminal control method by using this program.

### Variations

It should be noted that the configurations, operations, or the like of the authentication system according to the above example embodiments are examples and do not limit the configuration or the like of the system.

In the above embodiments, the operation of the authentication system has been described by taking a “face” of a person as an example of biometric information. However, the authentication system disclosed in the present application is also able to use other types of biometric information. For example, data with physical characteristics unique to the individual, such as fingerprints, voice prints, veins, retinas, and iris patterns of the eyes, may be used. That is, the biometric information of a user may be any information including physical features of the user.

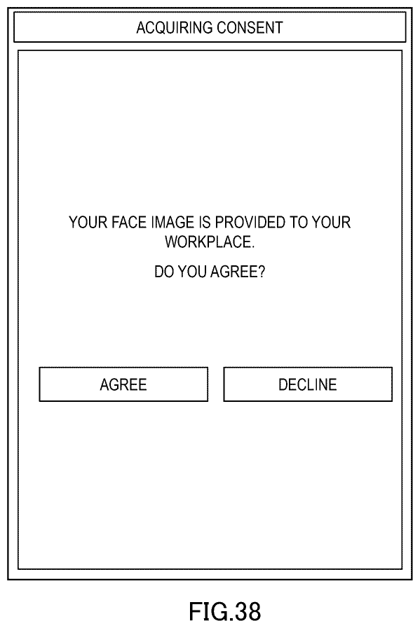

The terminal 40 of the user may acquire, from the user, consent to transmit original biometric information (for example, a face image) to a service provider each time an original providing request is received from the control server 10. Specifically, in a case where the original providing request is received, the service selection unit 504 of the terminal 40 acquires whether or not to provide original biometric information (for example, a face image) by using a GUI such as that shown in FIG. 38. In a case where the consent of the user related to the provision of original biometric information is acquired, the service selection unit 504 transmits the original biometric information stored internally to the control server 10.

In the above example embodiments, a case where the service server 20 generates authentication information (a feature value) corresponding to an authentication engine adopted by the own company itself has been described. However, generation of the authentication information (the feature value) may also be performed in the control server 10. Specifically, the control server 10 stores information of an authentication engine adopted by a service provider as part of business operator information. The control server 10 may generate registered authentication information (a feature value) that conforms to the above-described authentication engine from original biometric information acquired from the terminal 40, and transmit a user registration request including the generated registered authentication information to the control server 10.

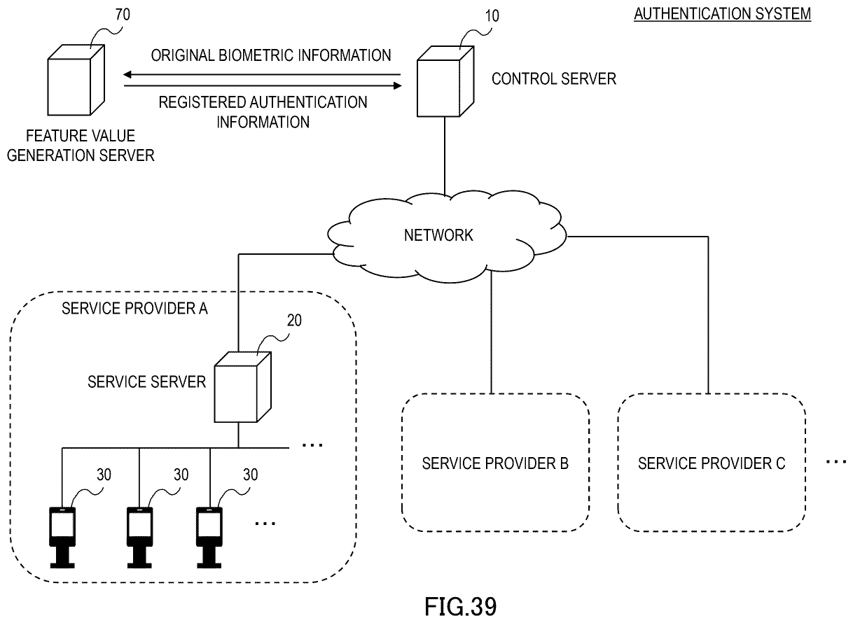

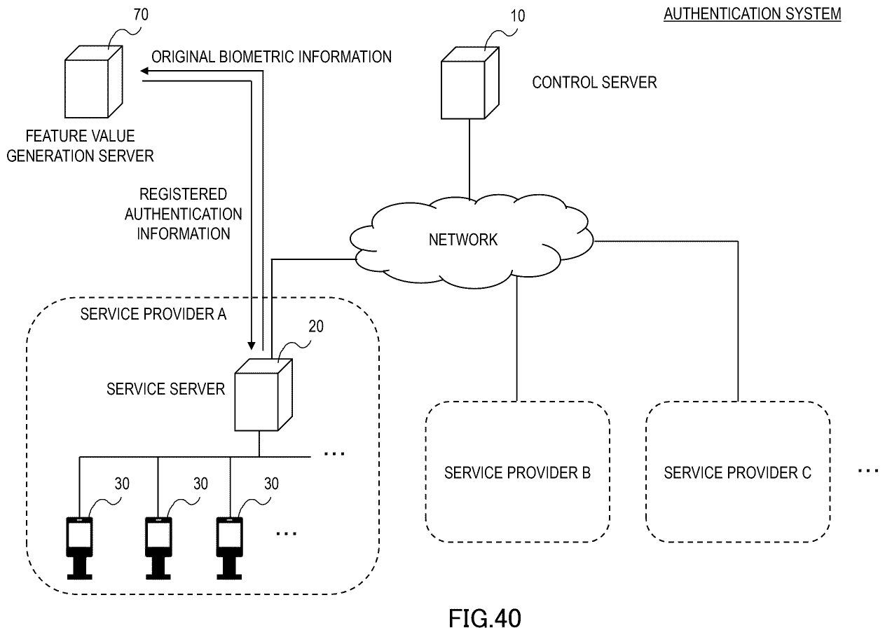

Alternatively, the service server 20 or the control server 10 may transmit original biometric information to a server specialized in generating feature values (a feature value generation server 70) shown in FIG. 39 and FIG. 40, and acquire registered authentication information from the server. In a case where the control server 10 or the service server 20 transmits original biometric information (for example, a face image) to the feature value generation server 70, the control server 10 or the service server 20 may also transmit information of an authentication engine adopted by the service provider to the feature value generation server 70. The feature value generation server 70 may generate registered authentication information (for example, a feature value) conforming to an authentication engine (an authentication algorithm) specified by the control server 10 or the service server 20, and reply to the control server 10 or the service server 20. In this way, the registered authentication information (the feature value) only needs to be generated on either the cloud side (the control server 10 side) or the edge side (the service server 20 side). It should be noted that detailed description of a configuration and operation of the feature value generation server 70 will be omitted because the configuration and operation are apparent from the above description.

In the above example embodiments, a case has been described in which the control server 10 specifies a service provider to be subjected to user registration by using a management code of a workplace or the like of a user. However, the control server 10 may specify a service provider to be subjected to user registration by using another method. For example, the control server 10 may provide an interface for selecting a service provider to be subjected to user registration from search results using a company name or the like, or may display, on the terminal 40, a list of service providers arranged in the Japanese syllabary order.

In the first example embodiment, a user (an employee) may register information of a visitor (a guest) to an office in the system. In this case, the employee performs a guest registration procedure by operating the terminal 40 and accessing the control server 10. The control server 10 acquires a name, an affiliation, a contact address, or the like of the guest from the employee. The control server 10 transmits a face image registration request to the acquired contact address (a terminal of the guest). For example, the control server 10 transmits a face image registration request including a URL. In a case where the guest clicks the URL, the terminal of the guest accesses the control server 10. The control server 10 acquires a face image of the guest and transmits the face image to the service server 20 of the office.

Further, the service server 20 of the office may control the activities of the guest using biometric authentication. For example, the service server 20 may determine, using biometric authentication, whether or not the guest is permitted to enter a meeting room. Alternatively, the service server 20 may control the use of a drink or the like by the guest using biometric authentication. For example, the service server 20 may control a vending machine in the office so as to provide the guest with a free drink only once.

In a case where a service provider belonging to the third type or the fourth type selected by a user does not have an account of the user, the user may generate an account of the user on a login page to which the user transitions by a redirect URL. In other words, the service server 20 may display guidance for generating an account of a new customer, or the like, on the login page.

The control server 10 may verify the identity of the user at the time of generation of an account of the user. Specifically, the control server 10 acquires, together with login information or the like of the user, an identity verification document on which biometric information is described (for example, a passport, a driver's license, or the like) and biometric information. The control server 10 performs a one-to-one matching using the biometric information in the identity verification document and the biometric information acquired from the user. In a case where the matching is successful, the control server 10 may perform user registration (system registration) of the user who has been successfully verified.

In the above example embodiments, a case has been described in which the account management database is configured inside the control server 10, but the database may be constructed in an external database server or the like. That is, some of the functions of the control server 10 may be implemented in another server. More specifically, the “service selection control unit (service selection control means)” or the like described above can be implemented in any of the apparatuses included in the system.

A data transmission and reception format among the respective apparatuses (the control server 10, the service server 20, and the authentication terminal 30) is not particularly limited, but data transmitted and received among these apparatuses may be encrypted. Among these apparatuses, biometric information or the like is transmitted and received, and in order to appropriately protect such information, it is desirable that encrypted data be transmitted and received.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that provides a biometric authentication service.

A part or the entirety of the example embodiments described above may be described as in the following supplementary notes, but is not limited to the followings.

### [Supplementary Note 1]

A server apparatus, including:
a service selection control means that enables a user to select a service provider, the service provider being one from which the user desires to receive a service, from among a plurality of service providers that provide services using biometric authentication; and
a storage means that stores information of the service provider that the user has selected,
wherein the service selection control means enables the user, at the time of selecting the service provider from which the user desires to receive the service, to distinguish between a service provider that has already been selected by the user and a service provider that has not yet been selected.

### [Supplementary Note 2]

The server apparatus according to supplementary note 1, wherein the storage means further stores information of a service provider whose selection has been canceled by the user, and
wherein the service selection control means enables the user, at the time of selecting the service provider from which the user desires to receive the service, to distinguish among a service provider that has already been selected by the user, a service provider that has never been selected by the user, and a service provider whose selection has been canceled by the user.

### [Supplementary Note 3]

The server apparatus according to supplementary note 2, further comprising a user registration control means that performs control to allow the service provider selected by the user to acquire original biometric information, which serves as an original of authentication information used for the biometric authentication, and
wherein the user registration control means acquires the original biometric information by requesting a terminal possessed by the user to provide the original biometric information, and transmits the acquired original biometric information to a server of the service provider selected by the user.

### [Supplementary Note 4]

The server apparatus according to supplementary note 3, wherein the service selection control means acquires a validity period of registered authentication information that is generated by the service provider selected by the user at the time the user selects the service provider from which the user desires to receive the service, and
wherein the user registration control means transmits the acquired original biometric information and the validity period to the server of the service provider selected by the user.

### [Supplementary Note 5]

The server apparatus according to supplementary note 4, wherein the storage means further stores information of the service provider for which the validity period is set in the registered authentication information, and
wherein the service selection control means displays, on the terminal possessed by the user, a message corresponding to the validity period related to the service provider for which the validity period is set in the registered authentication information.

### [Supplementary Note 6]

The server apparatus according to supplementary note 5, wherein the service selection control means acquires, from the user, an update instruction related to the validity period of the service provider for which the validity period is set in the registered authentication information.

### [Supplementary Note 7]

The server apparatus according to supplementary note 6, wherein the user registration control means transmits a validity period update instruction including an updated validity period to the server of the service provider for which the validity period update has been instructed.

### [Supplementary Note 8]

The server apparatus according to supplementary note 6, wherein the user registration control means transmit a validity period update instruction including an updated validity period and the original biometric information of the user to the server of the service provider for which the validity period update has been instructed.

### [Supplementary Note 9]

The server apparatus according to any one of supplementary notes 3 to 8, wherein the original biometric information is a face image.

### [Supplementary Note 10]

A system, including:
a terminal possessed by the user; and
a server apparatus, wherein the server apparatus includes:
a service selection control means that enables a user to select a service provider, the service provider being one from which the user desires to receive a service, from among a plurality of service providers that provide services using biometric authentication; and
a storage means that stores information of the service provider that the user has selected,
wherein the service selection control means enables the user, at the time of selecting the service provider from which the user desires to receive the service, to distinguish between a service provider that has already been selected by the user and a service provider that has not yet been selected.

### [Supplementary Note 11]

A control method of a server apparatus, the control method including: enabling a user to select a service provider, the service provider being one from which the user desires to receive a service, from among a plurality of service providers that provide services using biometric authentication;
storing information of the service provider that the user has selected; and
enabling the user, at the time of selecting the service provider from which the user desires to receive the service, to distinguish between a service provider that has already been selected by the user and a service provider that has not yet been selected.

### [Supplementary Note 12]

A computer-readable storage medium storing a program causing a computer mounted on a server apparatus to perform processing for:
enabling a user to select a service provider, the service provider being one from which the user desires to receive a service, from among a plurality of service providers that provide services using biometric authentication;
storing information of the service provider that the user has selected; and
enabling the user, at the time of selecting the service provider from which the user desires to receive the service, to distinguish between a service provider that has already been selected by the user and a service provider that has not yet been selected.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

### REFERENCE SIGNS LIST

10 control server
20 service server
30 authentication terminal
40 terminal
50 ticket management server
60 settlement server
70 feature value generation server
100 server apparatus
101 service selection control means
102 storage means
201 communication control unit
202 account management unit
203 business operator management unit
204 service selection control unit
205 user registration control unit
206 storage unit
301 communication control unit
302 business information management unit
303 user registration control unit
304 authentication unit
305 storage unit
311 processor
312 memory
313 input-output interface
314 communication interface
401 communication control unit
402 biometric information acquisition unit
403 authentication request unit
404 function realization unit
405 storage unit
501 communication control unit
502 account generation control unit
503 original information acquisition unit
504 service selection unit
505 storage unit

What is claimed is:

1. A server apparatus, comprising:
at least one memory storing a set of instructions; and
at least one processor configured to execute the set of instructions to:
enable a user to select a service provider, the service provider being one from which the user desires to receive a service, from among a plurality of service providers that provide services using biometric authentication; store information of the service provider that the user has selected; and
enable the user, at the time of selecting the service provider from which the user desires to receive the service, to distinguish between a service provider that has already been selected by the user and a service provider that has not yet been selected.

2. The server apparatus according to claim 1, wherein
the at least one processor is further configured to execute the set of instructions to:
store information of a service provider whose selection has been canceled by the user; and
enable the user, at the time of selecting the service provider from which the user desires to receive the service, to distinguish among a service provider that has already been selected by the user, a service provider that has never been selected by the user, and a service provider whose selection has been canceled by the user.

3. The server apparatus according to claim 2, wherein
the at least one processor is further configured to execute the set of instructions to:
perform control to allow the service provider selected by the user to acquire original biometric information, which serves as an original of authentication information used for the biometric authentication;
acquire the original biometric information by requesting a terminal possessed by the user to provide the original biometric information; and
transmit the acquired original biometric information to a server of the service provider selected by the user.

4. The server apparatus according to claim 3, wherein
the at least one processor is further configured to execute the set of instructions to:
acquire a validity period of registered authentication information that is generated by the service provider selected by the user at the time the user selects the service provider from which the user desires to receive the service; and
transmits the acquired original biometric information and the validity period to the server of the service provider selected by the user.

5. The server apparatus according to claim 4, wherein
the at least one processor is further configured to execute the set of instructions to:
store information of the service provider for which the validity period is set in the registered authentication information; and
display, on the terminal possessed by the user, a message corresponding to the validity period related to the service provider for which the validity period is set in the registered authentication information.

6. The server apparatus according to claim 5, wherein
the at least one processor is further configured to execute the set of instructions to acquire, from the user, an update instruction related to the validity period of the service provider for which the validity period is set in the registered authentication information.

7. The server apparatus according to claim 6, wherein
the at least one processor is further configured to execute the set of instructions to transmit a validity period update instruction including an updated validity period to the server of the service provider for which the validity period update has been instructed.

8. The server apparatus according to claim 6, wherein
the at least one processor is further configured to execute the set of instructions to transmit a validity period update instruction including an updated validity period and the original biometric information of the user to the server of the service provider for which the validity period update has been instructed.

9. The server apparatus according to claim 3, wherein the original biometric information is a face image.

10. A system, comprising:
a terminal possessed by the user; and
a server apparatus, wherein the server apparatus comprises:
at least one memory storing a set of instructions; and
at least one processor configured to execute the set of instructions to:
enable a user to select a service provider, the service provider being one from which the user desires to receive a service, from among a plurality of service providers that provide services using biometric authentication;
store information of the service provider that the user has selected; and
enable the user, at the time of selecting the service provider from which the user desires to receive the service, to distinguish between a service provider that has already been selected by the user and a service provider that has not yet been selected.

11. A control method of a server apparatus, the control method comprising:
enabling a user to select a service provider, the service provider being one from which the user desires to receive a service, from among a plurality of service providers that provide services using biometric authentication;
storing information of the service provider that the user has selected; and
enabling the user, at the time of selecting the service provider from which the user desires to receive the service, to distinguish between a service provider that has already been selected by the user and a service provider that has not yet been selected.

12. (canceled)
